(19) United States
(12) Patent Application Publication
(10) Pub. No.: US 2024/0324820 A1
(43) Pub. Date: Oct. 3, 2024

(54) A STORAGE VESSEL FOR A FOOD PROCESSING DEVICE

(71) Applicant: Breville Pty Limited, Alexandria, NSW 2015 (AU)

(72) Inventors: Simon Peter MOORE, Alexandria NSW 2015 (AU); Mark Anthony THOMAS, Alexandria NSW 2015 (AU)

(21) Appl. No.: 18/005,634

(22) PCT Filed: Jul. 19, 2021
(86) PCT No.: PCT/AU2021/050774

§ 371 Date: Jan. 16, 2023

(30) Foreign Application Priority Data
Jul. 17, 2020 (AU) 2020902479

(51) Int. Cl. A47J 43/07

(52) U.S. Cl. CPC A47J 43/0722; A47J 43/0772; A47J 2043/0738

(57) ABSTRACT

A storage structure 400 for a food processing device 10 with a bowl 16 for processing food using different accessories 82-88, that has a base unit 402 configured to fit within the bowl 16, and engagement formations 460, 474 to retain a plurality of the accessories 82-88 on the base unit 402 for individual removal from the base unit 402, and replacement into the base unit 402, without first removing or replacing another of the accessories 82-88.

### FIELD

The present invention relates to motorised food preparation appliances such as food processors. In particular, the invention relates to the storage of various accessories used in food processors.

The invention has been developed primarily for use with a food processing device and will be described hereinafter with reference to this application. However, it will be appreciated that the invention is not limited to this particular field of use.

### BACKGROUND

Food processors perform a variety of food preparation operations such as chopping, slicing, dicing and julienning as well as mixing, stirring or liquifying food stuffs within a preparation vessel such as a bowl. The different functions are normally performed by particular accessories mounted in the preparation bowl. A central hub or spindle in the bowl engages the accessory to drive one or more accessory parts during the processing operation.

Food processors are typically provided with multiple accessories to perform one or more of the food preparation operations exemplified above. Such accessories may include grating or shredding disks, adjustable slicers, dicing disks, dough blades, and chopping blades. When the food processor is not in use, the accessories may be stored in a vessel separate from the food processor. To accommodate multiple accessories, such vessels must be of sufficient size and configuration to safely and efficiently store the various accessories. Conventional storage vessels for food processor accessories can thus be large and bulky, thereby requiring a decent amount of kitchen space. Additionally, the arrangement of conventional storage vessels may not be able to effectively accommodate multiple accessories with exposed blades, for example, which can lead to safety and handling issues for the user. The accessories may alternatively be stored within the food processor preparation bowl itself, which in turn requires the bowl to have a large enough volume to accommodate the various accessories. The design of conventional food processor preparation bowls also does not typically lend itself to safe and efficient storage of multiple accessories.

Conventional storage vessels for food processing accessories tend to be large and bulky thereby occupying a substantial amount of kitchen space. Additionally, the arrangement of conventional storage vessels may not effectively accommodate multiple accessories with exposed cutting blades which can lead to safety concerns for the user when storing or retrieving accessories from the vessel. In some cases, the accessories are stored within the food processor preparation bowl itself if the bowl is volumetrically large enough to accommodate all the various accessories. However, the food processor preparation bowl is purpose built and designed for its food processing function rather than the correct and safe storage of multiple accessories, some with sharp cutting blades.

### SUMMARY

It is an object of the present invention to substantially overcome, or at least ameliorate, one or more of the disadvantages of existing arrangements, or at least provide a useful alternative to existing arrangements.

There is disclosed herein a storage vessel for a food processing device, the storage vessel comprising:
a body providing a storage cavity for receiving one or more accessories therein, the body including an upper rim portion and a lower portion extending from the upper rim portion;
the upper rim portion being adapted to cooperate with a lid and a bowl of the food processing device in a storage configuration, in which the lower portion at least partially extends into the bowl of the food processing device; and
the upper rim portion including at least one upper engagement member to engage a corresponding engagement member of the lid, and at least one lower engagement member to engage a corresponding engagement member of the bowl.

Preferably, the upper engagement member of the upper rim portion is a first recess and the corresponding engagement member of the lid is a first protrusion, whereby the lid is rotatable about a central longitudinal axis to move the first protrusion into the first recess to secure the lid in place relative to the storage vessel in the storage configuration.

Preferably, the first recess is in the form of a female bayonet feature and the first protrusion is in the form of a male bayonet feature.

Preferably, the lower engagement member of the upper rim portion is a second protrusion and the corresponding engagement member of the bowl is a second recess, whereby the storage vessel is rotatable about the central elongational axis to move the second protrusion into the second recess to secure the storage vessel in place relative to the bowl in the storage configuration.

Preferably, the second protrusion is in the form of a male bayonet feature and the second recess is in the form of a female bayonet feature.

Preferably, the storage cavity comprises an upper cavity surrounded by the upper rim portion and a lower cavity surrounded by the lower portion, the upper and lower cavities being separated by a partition having an opening therethrough.

Preferably, in the storage configuration, a spindle of the food processing device extends upwardly into the lower cavity and at least partially into the upper cavity through the opening in the partition.

Preferably, in the storage configuration, a first accessory of the food processing device is mounted on the spindle, and a second accessory is mounted on the first accessory so as to be contained within the lower cavity.

Preferably, the first accessory is a chopping blade and the second accessory is a dough blade.

Preferably, in the storage configuration, a third accessory of the food processing device is mounted on the second accessory so as to be contained within the upper cavity.

Preferably, the third accessory is an adjustable slicer.

Preferably, the storage configuration, a fourth accessory of the food processing device is mounted on the third accessory so as to be also contained within the upper cavity.

Preferably, the fourth accessory is a shredding disk.

Preferably, a first air gap is provided between the third accessory and the partition of the storage cavity.

Preferably, a second air gap is provided between the first accessory and the lid of the food processing device.

There is also disclosed herein storage vessel for a food processing device, the storage vessel comprising:
a body providing a storage cavity for receiving one or more accessories therein, the body including an upper rim portion and a lower portion extending from the upper rim portion;
the upper rim portion being adapted to cooperate with a lid and a bowl of the food processing device in a storage configuration, in which the lower portion at least partially extends into the bowl of the food processing device; and
the upper rim portion including a pair of gripping members that extend from the upper rim portion.

Preferably, the gripping members are each in the form of a tab that extends transversely from the upper rim portion.

There is also disclosed herein a storage vessel for a food processing device, the storage vessel comprising:
a body providing a storage cavity for receiving one or more accessories therein, the body including an upper rim portion and a lower portion extending from the upper rim portion;
the upper rim portion being adapted to cooperate with a lid and a bowl of the food processing device in a storage configuration, in which the lower portion at least partially extends into the bowl of the food processing device;
the upper rim portion including at least one upper engagement member to engage a corresponding engagement member of the lid, and at least one lower engagement member to engage a corresponding engagement member of the bowl;
the body further including a cover portion extending from the upper rim portion to prevent contact between an interlock portion of the lid and an interlock portion of the bowl.

Preferably, the cover portion includes a first arm extending transversely from the upper rim portion and a second arm extending transversely from the first arm.

Preferably, the cover portion provides an air gap between the interlock portion of the lid and the interlock portion of the bowl.

There is also disclosed herein a storage vessel for a food processing device, the storage vessel comprising:
a body providing a storage cavity for receiving one or more accessories therein, the body including an upper rim portion and a lower portion extending from the upper rim portion;
the upper rim portion being adapted to cooperate with a lid and a bowl of the food processing device in a storage configuration, in which the lower portion at least partially extends into the bowl of the food processing device;
the upper rim portion including a pair of gripping members that extend from the upper rim portion; and
the body further including a cover portion extending from the upper rim portion to prevent contact between an interlock portion of the lid and an interlock portion of the bowl.

Preferably, the gripping members are each in the form of a tab that extends transversely from the upper rim portion.

Preferably, the cover portion includes a first arm extending transversely from the upper rim portion and a second art arm extending transversely from the first arm.

Preferably, the cover portion provides an air gap between the interlock portion of the lid and the interlock portion of the bowl.

There is also disclosed herein a storage vessel for a food processing device, the storage vessel comprising:
a body providing a storage cavity for receiving one or more accessories therein, the body including an upper rim portion and a lower portion extending from the upper rim portion;
the upper rim portion being adapted to cooperate with a lid and a bowl of the food processing device in a storage configuration, in which the lower portion at least partially extends into the bowl of the food processing device;
the upper rim portion including at least one upper engagement member to engage a corresponding engagement member of the lid, and at least one lower engagement member to engage a corresponding engagement member of the bowl; and
the upper rim portion further including a pair of gripping members that extend from the upper rim portion.

There is also disclosed herein a food processing device comprising:
a motorised base;
a food preparation bowl adapted to engage the motorised base, wherein operation of the motorised base drives rotation of a spindle that is operatively associated with the bowl;
a lid positionable on the bowl to cover a top opening of the bowl; and
a storage vessel positionable between the lid and the bowl, the storage vessel including a body that provides a storage cavity for receiving one or more accessories therein, the storage vessel having an upper portion adapted to cooperate with the lid and the bowl of the food processing device in a storage configuration, in which the lower portion at least partially extends into the bowl of the food processing device.

Preferably, the upper rim portion includes at least one upper engagement member to engage a corresponding engagement member of the lid, and at least one lower engagement member to engage a corresponding engagement member of the bowl.

One aspect of this disclosure provides a storage structure for a food processing device with a bowl for processing food using different accessories, the storage structure comprising:
a base unit configured to fit within the bowl, and
engagement formations to retain a plurality of the accessories on the base unit for individual removal from the base unit, and replacement into the base unit, without first removing or replacing another of the accessories.

A second aspect of this disclosure provides a storage structure for food processing device with a bowl for processing food using different accessories, the storage structure comprising:
a base unit configured to fit within the bowl, and,
formations provided on the base unit to detachably retain each of the accessories, the formations configured for individual detachment of each of the accessories without first detaching another of the accessories.

A third aspect of this disclosure provides a storage structure for a food processing device with a bowl for processing food using different accessories, the storage structure comprising:

a base unit configured to fit within the bowl, the base unit having recesses to store the accessories, the recesses being configured for individual removal of each of the accessories without removal of another of the accessories.

A fourth aspect of this disclosure provides a storage structure for a food processing device with a bowl for processing food using different accessories, the storage structure comprising:

a base unit configured to fit within the bowl, the base unit having recesses to store the accessories, the recesses being configured for individual removal of each of the accessories without removal of another of the accessories.

A fifth aspect of this disclosure provides a storage structure for a food processing device with a bowl for processing food using different accessories rotatably driven by a spindle operatively connected to a motorised base via a drive coupling within the bowl, the storage structure comprising:

a base unit configured to fit within the bowl, and the base unit having a cavity to accommodate the drive coupling when in the bowl such that the drive coupling is spaced from contact with any part of the base unit and the accessories retained by the base unit.

A sixth aspect of this disclosure provides a storage structure for a food processing device with a bowl for processing food using different accessories, the storage structure comprising:
a base unit configured to fit within the bowl;
formations provided on the base unit to engage the accessories for individual removal from the storage structure without removal of another of the accessories; and,
a lift portion for manually lifting the storage structure from the bowl without user contact with any of the accessories.

Preferably, the base unit has recesses to store the accessories, each of the recesses having at least one of the engagement formations to detachably engage the accessories such that the accessories are stored within the recesses to prevent direct contact of one of the accessories with another of the accessories.

Preferably, the food processing device has a spindle to engage the accessories for rotation within the bowl, and some of the engagement formations are configured to retain the spindle, such that the spindle is removable from the base unit without requiring removal of any of the accessories stored in the base unit.

Preferably, the base unit has a socket to receive the spindle, the socket having a plurality of the formations for detachably gripping the spindle during storage and allowing manual removal of the spindle by a user.

Preferably, at least one of the recesses is configured for storing a designated one of the accessories only.

Preferably, the storage structure further comprises a removable mount in the at least one recess, the removable mount having the formations to detachably engage the accessory for storage within the recess.

Preferably, the removable mount and the at least one recess have complementary bayonet tabs and apertures forming a bayonet connection between the mount and the recess.

Preferably, the storage structure further comprises a cover for attachment to the base unit, the cover and the base unit defining at least one slot to retain one of the accessories formed as a disk for rotation in the bowl.

Preferably, the cover and the base unit define a plurality of the slots to individually retain one of the disks respectively.

Preferably, the storage structure further comprises an additional unit for detachable engagement with the cover, the additional unit being configured to hold an additional accessory for the food processing device, such that the additional unit does not prevent removal of any of the plurality of accessories stored in the storage structure.

Preferably, the bowl has a base with a spindle drive coupling, and the storage structure further comprises a drive coupling cavity for accommodating the spindle drive coupling when the base unit is within the bowl such that the spindle drive coupling does not touch any part of the storage structure or the plurality of accessories.

Preferably, the storage structure is configured to be lifted out of the bowl without requiring user contact with any of the accessories. Optionally, the cover has a lift handle with hinged connection for rotation to an upright orientation to lift the storage structure from the bowl. In another option, the additional unit has lift tabs for lifting the storage structure from the bowl.

Preferably, the plurality of accessories includes one or more of:
a. a chopping blade;
b. a dough blade;
c. an adjustable slicing disk; and
d. an adjustable shredding disk.

Preferably, the additional accessory is a dicing kit.

Preferably, the food processing device has a lid for the bowl wherein the storage structure is configured to fit in the bowl with the lid on the bowl.

Preferably, the food processing device has a lid for the bowl wherein the additional unit is configured to receive the lid to cover the additional accessory.

A seventh aspect of this disclosure provides a storage structure for a food processing device with a bowl for processing food using different accessories, the storage structure comprising:
a body which stores at least one accessory, wherein the body is configured to fit within the bowl.

Preferably the body houses/encloses the at least one accessory.

Preferably the body comprises a lift portion for manually lifting the storage structure from the bowl without user contact with any of the accessories.

Preferably the body defines at least one formation shaped to correspond with a peripheral profile of the at least one accessory to provide a visual indication of a correct storage location for the at least one accessory.

An eighth aspect of this disclosure provides a storage structure for a food processing device with a bowl for processing food using different accessories, the storage structure comprising:
a body which stores a plurality of accessories, wherein a plurality of accessories comprises a first and a second accessory;
at least one formation to allow the first accessory nests and/or stacks on the second accessory.

A ninth aspect of this disclosure provides a storage structure for a food processing device with a bowl for processing food using different accessories, the storage structure comprising:
a body which stores at least one accessory, wherein the body is configured to fit within the bowl;
at least one formation to provide access for the user to remove the at least one accessory from and/or replace the at least one accessory into the body.

A tenth aspect of this disclosure provides a storage structure for a food processing device with a bowl for processing food using different accessories, the storage structure comprising:
a body which stores a plurality of accessories, wherein a plurality of accessories comprises a first and a second accessory, wherein the first accessory comprises an engagement feature to securely retain the second accessory within the body.

### BRIEF DESCRIPTION OF THE DRAWINGS

Preferred embodiments of the present invention will be described by way of example only, with reference to the accompanying drawings, in which:

FIG. 1 is a schematic isometric view of a food processing device;

FIG. 2 is a schematic isometric view of a storage vessel of the food processing device shown in FIG. 1;

FIG. 3 is a schematic isometric exploded parts view of the food processing device shown in FIG. 1;

FIG. 4 is a schematic side sectional view of the food processing device shown in FIG. 1;

FIG. 4A is an enlarged section view of various component of the food processing device shown in FIG. 4;

FIG. 5 is a further schematic isometric view of the food processing device shown in FIG. 1;

FIG. 6 is a schematic side sectional view of the storage vessel, lid and bowl of the food processing device shown in FIG. 1;

FIG. 7 is a schematic side exploded parts view of various accessories of the food processing device shown in FIG. 1;

FIG. 8 is a schematic side view of the various accessories shown in FIG. 7 in an assembled state;

FIG. 9 is a schematic isometric view of the various accessories shown in FIG. 7 in an assembled state;

FIG. 10 is a schematic isometric view of the storage vessel of the food processing device shown in FIG. 1 with an accessory stored therein;

FIGS. 11 and 12 show various modes of assembly and disassembly of the storage vessel of the food processing device shown in FIG. 1;

FIG. 13 is a schematic side sectional view of the storage vessel and lid of the food processing device shown in FIG. 1;

FIG. 14 is a schematic isometric view of another embodiment of a food processing device;

FIG. 15 is a schematic isometric view of a storage vessel of the food processing device shown in FIG. 14;

FIG. 16 is a schematic isometric exploded parts view of the food processing device shown in FIG. 14;

FIGS. 17 and 18 show various modes of assembly and disassembly of the storage vessel of the food processing device shown in FIG. 14;

FIGS. 18A, 18B and 18C show another form of the storage vessel in which one of the food processing accessories is detachably held in the lower cavity;

FIG. 19 is a schematic isometric view of another embodiment of a food processing device;

FIG. 20 is a perspective view of a food processor with a storage structure for food processing accessories according to a first embodiment;

FIG. 21 is a perspective view of a food processor with a storage structure according to a second embodiment;

FIG. 22 is an exploded perspective of the food processor and the storage structure according to the first embodiment shown in FIG. 20;

FIG. 23 is an exploded perspective of the food processor and the storage structure according to the second embodiment as shown in FIG. 21;

FIG. 24 is a sectioned view of the storage structure according to a first embodiment;

FIG. 25 is a sectioned view of the storage structure according to the second embodiment;

FIG. 26 is a front, right side perspective of a base unit of the storage structure;

FIG. 27 is a rear, left side perspective of the base unit;

FIG. 28 is a rear, right side perspective of the base unit;

FIG. 29 is a front, left side perspective of the base unit;

FIG. 30 is a front, right side perspective of the storage structure according to the second embodiment with an additional unit in the locked position on the cover attached to the base unit;

FIG. 31 is a rear, left side perspective of the storage structure shown in FIG. 30;

FIG. 32 is a rear, right side perspective of the storage structure shown in FIG. 30;

FIG. 33 is a front, left side perspective of the storage structure shown in FIG. 30;

FIG. 34 is a front, right side perspective of the cover for the base unit;

FIG. 35 is a rear, left side perspective of the cover of FIG. 34;

FIG. 36 is a rear, right side perspective of the cover of FIG. 34;

FIG. 37 is a front, left side perspective of the cover of FIG. 34;

FIG. 38 is an exploded perspective of the storage structure according the first embodiment with the processing accessories spaced from the storage structure in their respective directions of removal/replacement;

FIG. 39 is an exploded perspective of the storage structure according to the second embodiment with the processing accessories spaced from the storage structure in their respective directions of removal/replacement;

FIG. 40 is a front, left side perspective of the storage structure according to the first embodiment with the shredding disk and adjustable slicer disk inserted in the shredding disk slot and the adjustable slicer slot respectively;

FIG. 41 is a front, left side perspective of the storage structure according to the second embodiment with the dicing kit in the additional unit on the base unit;

FIG. 42 is a plan view of the additional unit on the cover of the base unit with the additional unit in the unlocked position;

FIG. 43 is a front, left side perspective of the storage structure according to the second embodiment with the additional unit in the unlocked position on the cover of the base unit;

FIG. 44 is an exploded perspective of the storage structure according to the second embodiment with the spindle socket, chopping blade mount, dough blade mount and lift handle disassembled;

FIG. 45 is an exploded perspective of the base unit with the spindle socket, the chopping blade mount and the dough blade mount disassembled;

FIG. 46 is a left side elevation of the storage structure according to the first embodiment showing the dough blade recess in the base unit;

FIG. 47 is a section view of the storage structure according to the first embodiment without the processing accessories or the spindle socket, chopping blade mount and dough blade mount; and

FIG. 48 is a front left side perspective of the storage structure according to the first embodiment with the lift handle rotated to an upright configuration.

### DETAILED DESCRIPTION OF EMBODIMENTS

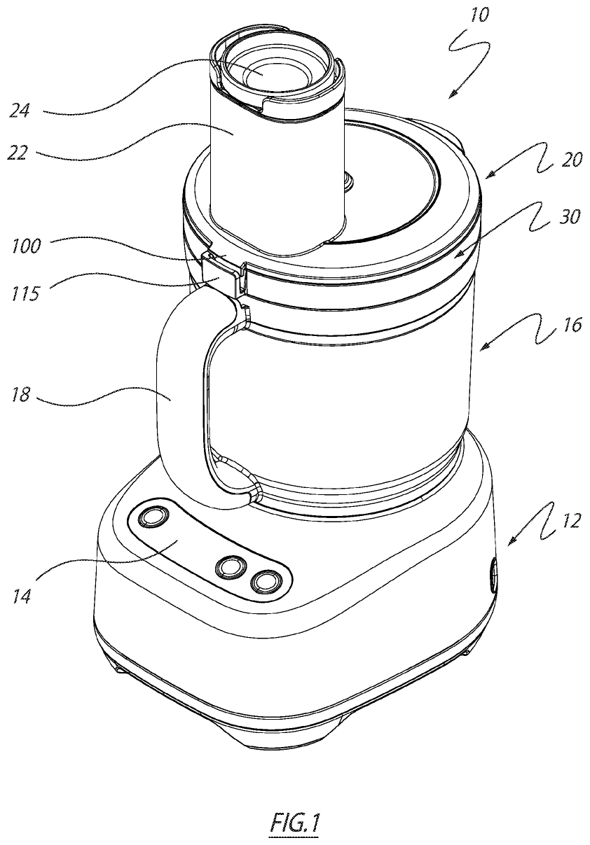

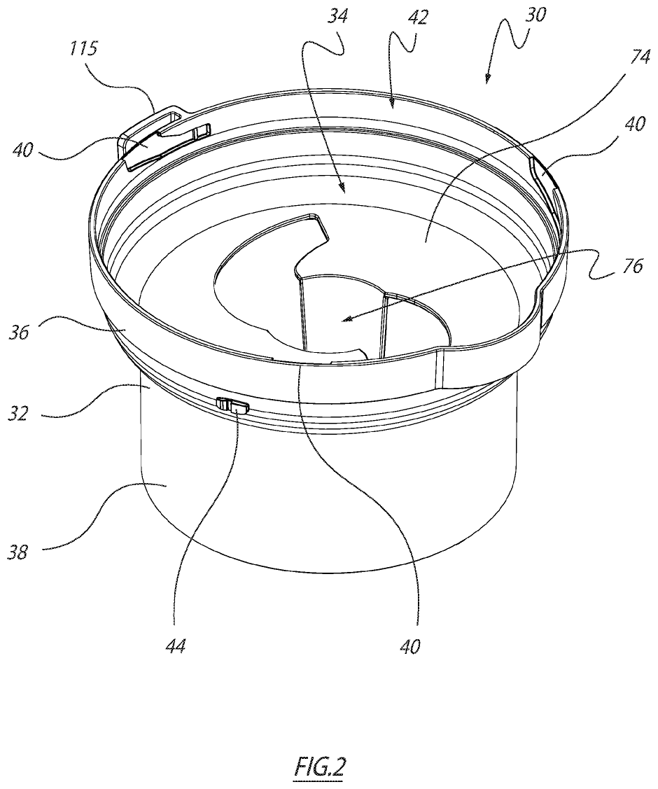

In FIG. 1 of the accompanying drawings, there is schematically depicted a food processing device 10 including a motorised base 12 having a user interface 14 to facilitate user control the operation of the motorised base 12. The food processing device 10 further includes a food preparation vessel or container in the form of a bowl 16 that engages the base 12. The bowl includes a handle 18. The top of the bowl 16 is closed with a lid 20 having a feed tube 22 for safely inserting food into the bowl 16. A pusher 24 may be provided to guide food that is inserted into the feed tube 22 into the bowl 16. The food processing device 10 as depicted further includes a storage vessel 30 located between the bowl 16 and the lid 20.

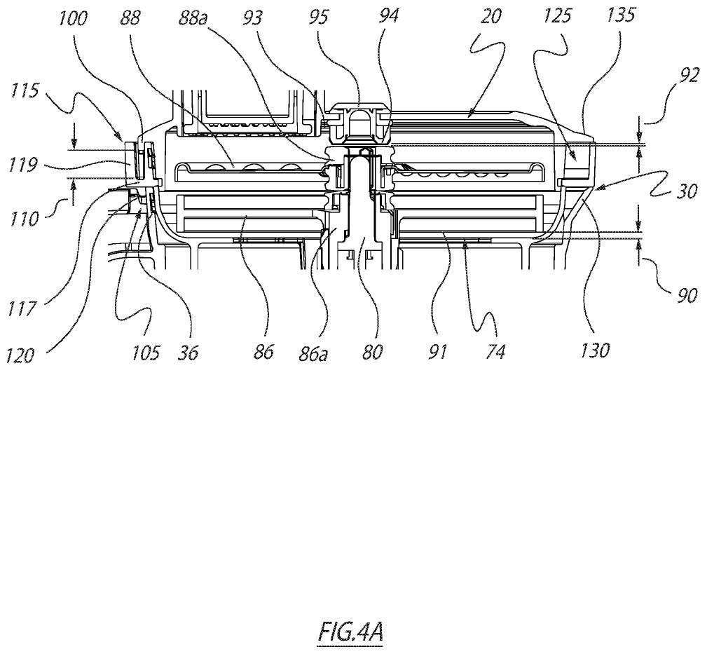

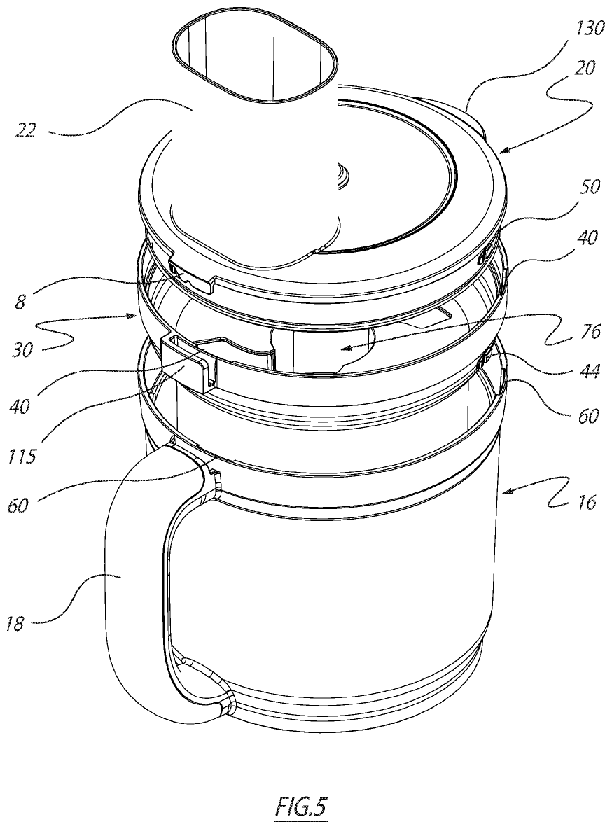

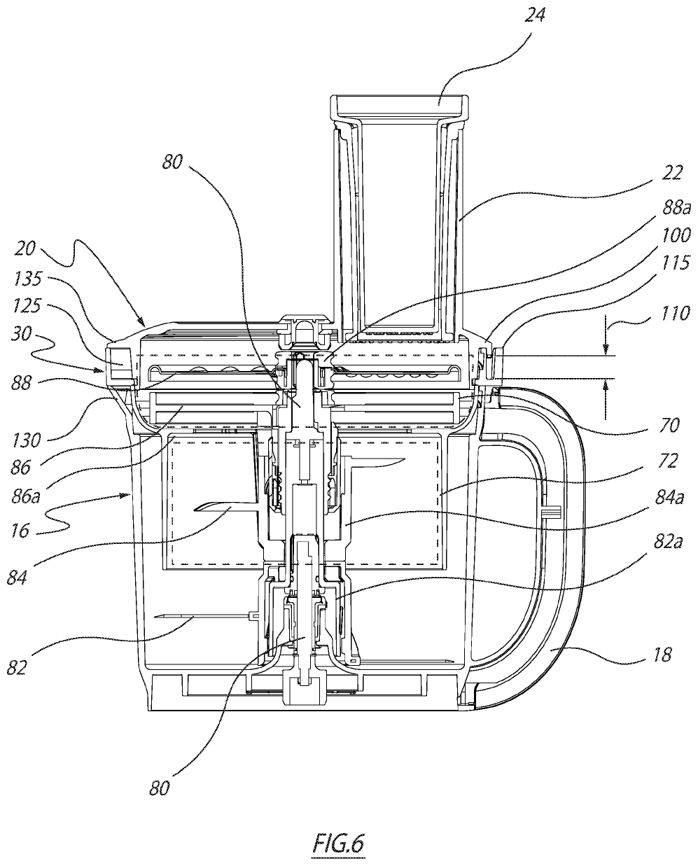

FIG. 2 depicts an embodiment of the storage vessel 30 having a body 32 that provides a storage cavity 34 for receiving one or more food processing accessories therein. In preferred forms, the body 32 is formed from high wear-resistance material such as Tritan or SAN. The body 32 includes an upper rim portion 36 and a lower portion 38 extending from the upper rim portion 36. The upper rim portion 36 is adapted to cooperate with the lid 20 and the bowl 16 of the food processing device 10 in a storage configuration, in which the lower portion 38 at least partially extends into the bowl 16 (see FIGS. 4 and 6).

The upper rim portion 36 includes at least one upper engagement member 40. In the depicted embodiment, the upper rim portion 36 includes three upper engagement members 40, each in the form of an elongated recess or female bayonet feature that extends along an inner face 42 of the upper rim portion 36. It will be appreciated that in other embodiments (not shown), the upper rim portion 36 may be provided with any number of upper engagement member(s) 40 which may alternatively be in the form of a protrusion, rail, or other suitable mechanical interfacing feature. It will also be appreciated that the upper engagement member(s) 40 may be located anywhere on the upper rim portion 36.

The upper rim portion 36 further includes at least one lower engagement member 44. In the depicted embodiment, the upper rim portion 36 includes three lower engagement members 44, each in the form of a protrusion or a male bayonet feature. It will be appreciated that in other embodiments (not shown), the upper rim portion 36 may be provided with any number of lower engagement member(s) 44, which may alternatively be in the form of a recess, rail, or other suitable mechanical interfacing feature. It will also be appreciated that the lower engagement member(s) 44 may be located anywhere on the upper rim portion 36, and in some embodiments (not shown), the lower engagement member(s) 44 may alternatively be located on the lower portion 38.

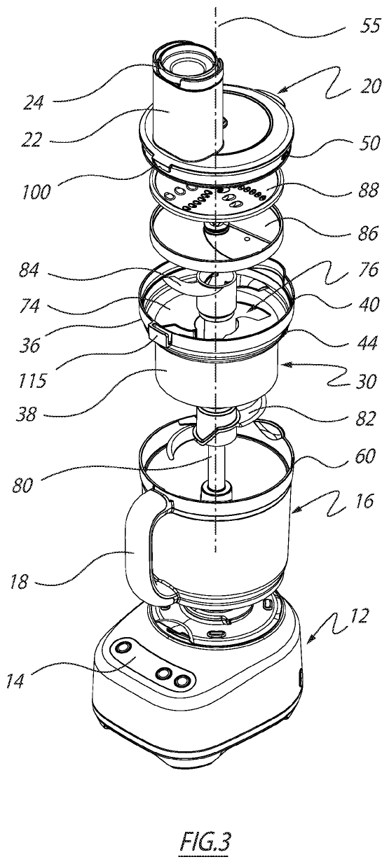

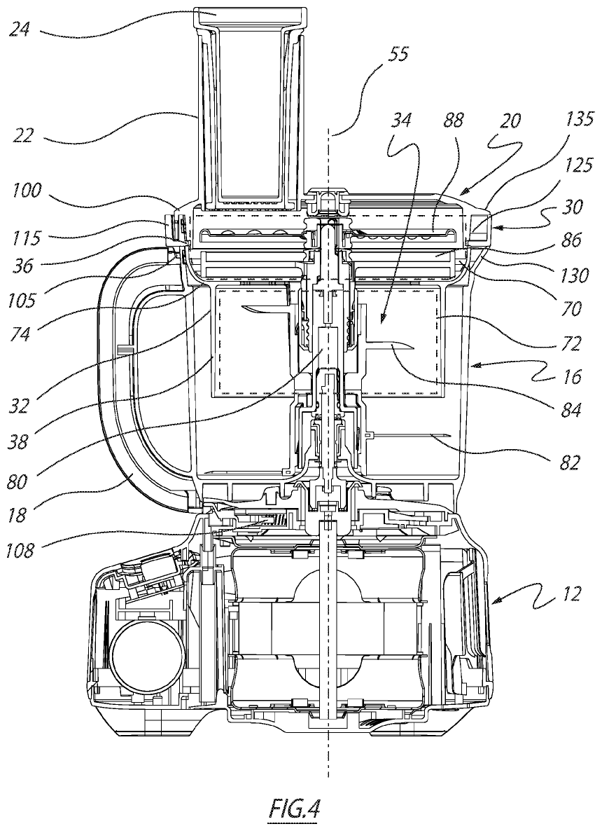

Referring to FIG. 3, the lid 20 includes at least one lid engagement member 50. In the depicted embodiment, the lid 20 includes three lid engagement members 50, each in the form of a protrusion or male bayonet feature that corresponds to a respective recess or female bayonet feature of the three upper engagement members 40 of the upper rim portion 36. The lid 20 is rotatable about a central longitudinal axis 55 (or alternatively, the storage vessel 30 is rotatable relative to the axis 55) to move the three lid engagement members 50 into the respective upper engagement members 40 to secure or lock the lid 20 in place relative to the storage vessel 30 in the storage configuration.

The bowl 16 includes at least one bowl engagement member 60. In the depicted embodiment, the bowl 16 includes three bowl engagement members 60, each in the form of a recess or female bayonet feature that corresponds to a respective protrusion or male bayonet feature of the three lower engagement members 44 of the upper rim portion 36. The bowl 16 is rotatable about the central longitudinal axis 55 (or alternatively, the storage vessel 30 is rotatable about the axis 55) to move the three lower engagement members 44 into the respective bowl engagement members 60 to secure or lock the storage vessel 30 in place relative to the bowl 16 in the storage configuration.

As discussed above in respect of the upper and lower engagement members 40 and 44, it will be appreciated that the lid 20 and bowl 16 may be provided with any number of lid and bowl engagement member(s) 50 and 60, respectively. The lid and bowl engagement member(s) 50 and 60 may be in any form of a protrusion or male bayonet feature, a recess or female bayonet feature, rail, or other suitable mechanical interfacing feature. It will also be appreciated that the lid and bowl engagement member(s) 50 and 60 may be located anywhere on the lid 20 and bowl 16, respectively.

As will be described in further detail below, it will be understood that the storage vessel 30 may be removed and separated from the overall food processing device 10 assembly so as to facilitate an operating configuration of the food processing device 10. In the operating configuration, the lid 20 is engaged with the bowl 16 to allow the motorised base 12 to operate. It will thus be appreciated that the lid engagement member(s) 50 are also adapted to engage the bowl engagement member(s) 60 to secure or lock the lid 20 in place relative to the bowl 16 in the operating configuration. As discussed above, the lid 20 is rotatable about a central longitudinal axis 55 to move the three lid engagement members 50 into the respective bowl engagement members 60 to secure or lock the lid 20 in place relative to the storage vessel 30 in the operating configuration.

Referring to FIG. 4, which shows the storage configuration of the food processing device 10, the storage cavity 34 comprises an upper cavity 70 surrounded by the upper rim portion 34 and a lower cavity 72 surrounded by the lower portion 38. The upper cavity 70 is located adjacent the lid 20 and the lower cavity is located adjacent and within the bowl 16. The upper and lower cavities 70 and 72 are separated by a partition 74 of the storage vessel body 32. In the depicted embodiment, the partition 74 extends transversely relative to the central longitudinal axis 55. The partition 74 includes an opening 76 (see FIGS. 2 and 3) and in the depicted embodiment, the opening 76 has a cross-sectional shape corresponding to the shape of a dough blade accessory, as will be described in further detail below.

As best shown in FIGS. 4 and 6, the food processing device 10 includes a spindle (rotating shaft) 80 that extends upwardly along the central longitudinal axis 55 into the lower cavity 72. The spindle 80 also extends at least partially into the upper cavity 70 through the opening 76 in the partition 74. It will be understood that the spindle 80 engages one or more accessories for rotation at a speed suitable for a food processing operation (e.g. peeling, slicing, shredding, chopping, mixing etc.).

In the depicted embodiment, the food processing device 10 includes a first accessory 82 that is mounted on the spindle 80, and a second accessory 84 that is mounted on the first accessory 82. It will be understood that the first and second accessories 82 and 84 each include a hub having a central opening through which the spindle 80 may extend. In the depicted embodiment, the first accessory 82 is a chopping blade and the second accessory 84 is a dough blade. In the storage configuration as shown, the chopping blade is located in the bowl 16 and below the lower cavity 72, whilst the dough blade is located and contained within the lower cavity 72.

The food processing device 10 also includes a third accessory 86 that is mounted on the second accessory 84, and a fourth accessory 88 that is mounted on the third accessory 86. It will be understood that the third and fourth accessories 86 and 88 also each include a hub having a central opening through which the spindle 80 may at least partially extend. In the depicted embodiment, the third accessory 86 is an adjustable slicer and the fourth accessory 88 is a shredding disk. In the storage configuration as shown, the adjustable slicer and the shredding disk are both located and contained within the upper cavity 70.

It will be appreciated that the first, second, third and fourth accessories 82, 84, 86 and 88 are not limited by the configuration or accessory type as shown in the drawings and described above. The arrangement as shown may, however, allow for the accessories to be stacked/nested or otherwise assembled in close proximity to one another so as to minimise the size or volume of the bowl 16 required to accommodate all accessories.

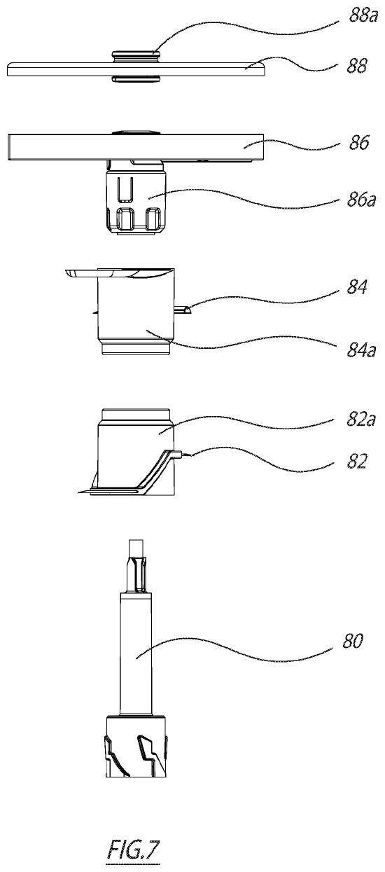

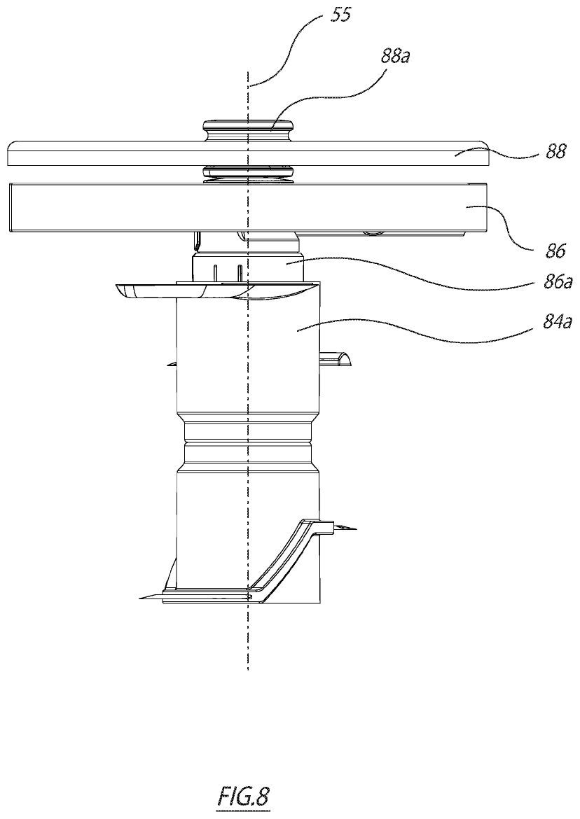

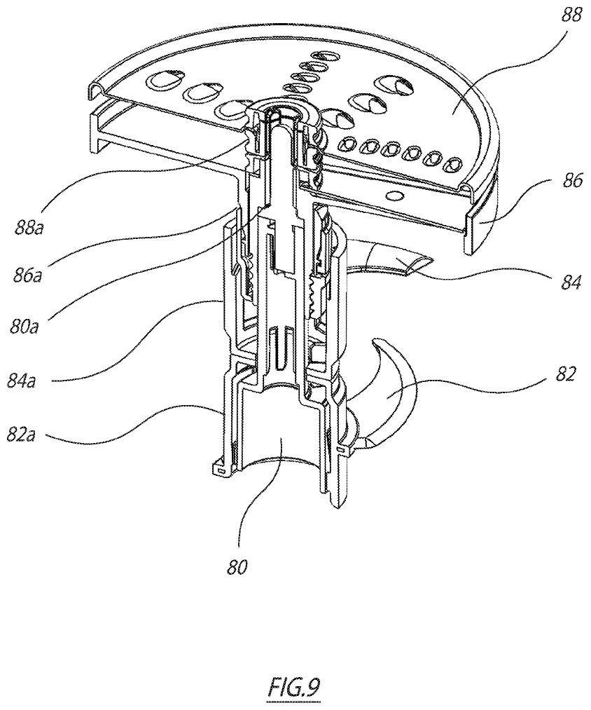

The assembly of the accessories is best shown in FIGS. 7 to 9. In FIG. 7, an exploded parts view of the first, second, third and fourth accessories 82, 84, 86 and 88 is shown, isolated from the storage vessel 30 FIGS. 8 and 9 show the first, second, third and fourth accessories 82, 84, 86 and 88 in an assembled state, again isolated from the storage vessel 30.

As best shown in FIG. 9, a hub 82a of the first accessory (chopping blade) 82 is placed onto the spindle 80 such that the spindle 80 extends through a central opening of the hub 82a. The hub 82a of the first accessory (chopping blade) 82 then engages the spindle 80 so as to mount the first accessory 82 thereon. Likewise, a hub 84a of the second accessory 84 (dough blade) is placed on the spindle 80 such that the spindle 80 extends through a central opening of the hub 84a. The hub 84a of the second accessory (dough blade) 84 then engages the hub 82a of the first accessory (chopping blade) 82 so as to be mounted thereon. In the depicted embodiment, the hub 84a of the second accessory (dough blade) 84 is an upside-down orientation to facilitate placement onto the hub 82a of the first accessory (chopping blade) 82. As such, the top surface of the hub 84a abuts the top surface of the hub 82a in the assembled state. To facilitate placement of the second accessory (dough blade) 84 on to the spindle 80 (and on to the hub 82a of the first accessory 82), the opening 76 of the partition 74 has a cross-sectional shape that corresponds to the shape of the second accessory (dough blade) 84.

A hub 86a of the third accessory 86 (adjustable slicer) is also placed onto the spindle 80 such that the spindle 80 at least partially extends through a central opening of the hub 86a. The hub 86a of the third accessory (adjustable slicer) 86 then engages the hub 84a of the second accessory (dough blade) 84 so as to be mounted thereon. In the depicted embodiment, the hub 86a of the third accessory (adjustable slicer) 86 is placed at least partially inside the hollow hub 84a of the second accessory (dough blade) 84 so as to be mounted or nested therein. A hub 88a of the fourth accessory (shredding disk) 88 is then placed on to the spindle 80 such that the spindle 80 at least partially extends through a central opening of the hub 88a, which in turn engages the hub 86a of the third accessory (adjustable slicer) 86 so as to be mounted thereon.

Returning to FIG. 4A, a first air gap 90 is provided between the partition 74 of the storage vessel 30 and a bottom edge 91 of the third accessory (adjustable slicer) 86. A second air gap 92 is also provided between a top surface 93 of the hub 88a of the fourth accessory (shredding disk) 88 and the lid 20. More particularly, the second air gap 92 is provided between the top surface 93 and a bottom surface 94 of a bushing 95 in the lid 20. It will be appreciated that spindle 80 and/or the interior surface of the hub 84a may include stop or engagement features, such that when the third and second accessories 86 and 88 are mounted on the spindle 80, they are held in place at a predetermined location or distance along the spindle 80, thereby providing the air gaps 90 and 92. For example, and as best shown in FIG. 9, the spindle 80 includes a shoulder portion 80a which acts as the stop/engagement feature for the hub 86a of the third accessory 86 when it is placed onto the spindle 80.

The air gap 92 may at least prevent contact between the fourth accessory 88 and the underside of the lid 20. Likewise, the air gap 90 may at least prevent contact between the third accessory 86 and the storage vessel 30. In this way, it will be appreciated that wear and tear to the third and fourth accessories 86 and 88 may be reduced or eliminated, for example, from repeated assembly/disassembly of the various parts, and also during transportation of the food processing device 10.

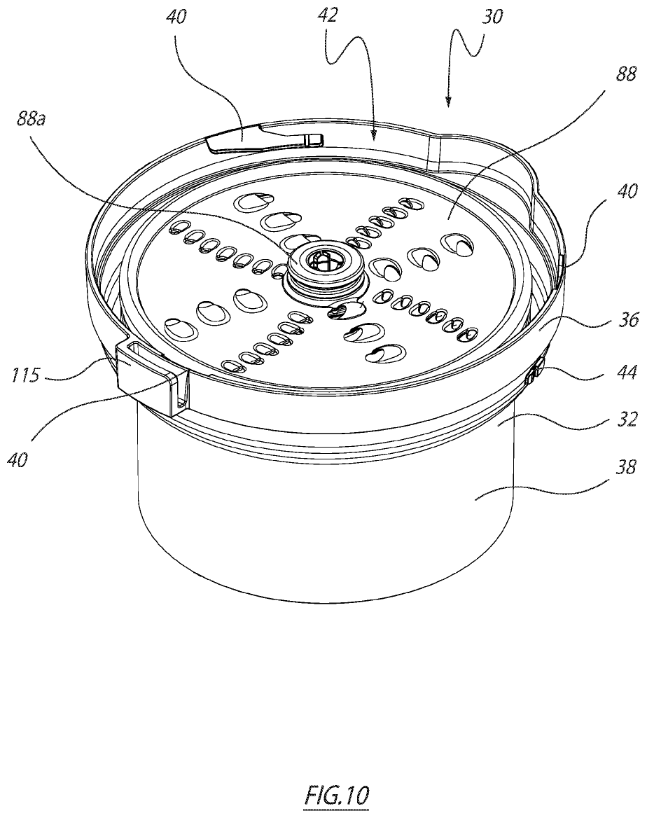

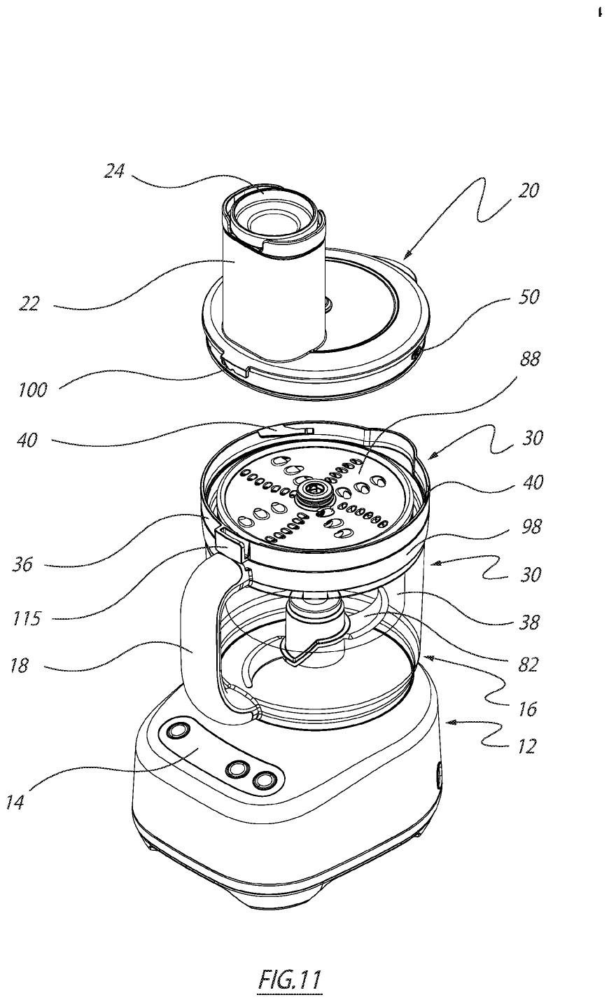

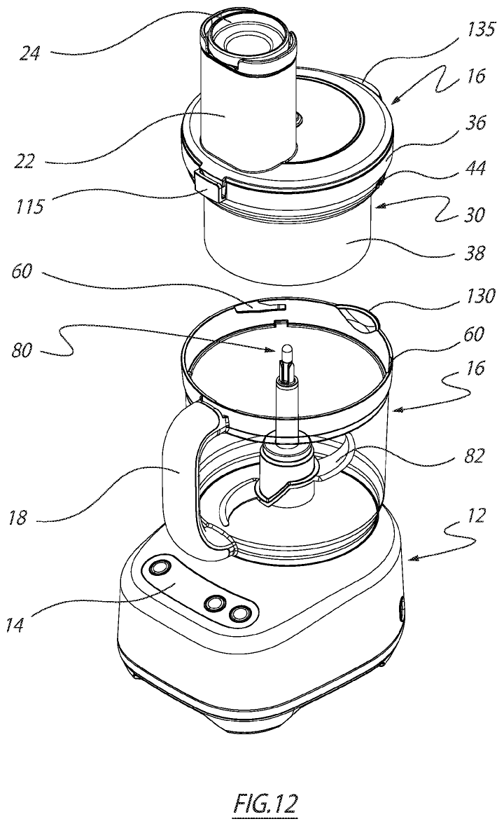

FIG. 10 shows the assembled state of the storage vessel 30 and at least the fourth accessory 88. FIGS. 11 and 12 show various assembly options or methods for the storage vessel 30. In FIG. 11, the bowl 16 is shown to be mounted on the base 12, with the storage vessel 30 being mounted on the bowl 16. The upper rim portion 36 of the storage vessel 30 engages an upper rim 98 of the bowl 16, and the lower portion 38 of the storage vessel 30 extends into the bowl 16.

In the embodiment as shown in FIG. 11, the first accessory (chopping blade) 82 and the fourth accessory (shredding disk) 88 are visible, although it will be understood that the second and third accessories (dough blade and adjustable slicer) 84 and 86 are also present but hidden from view. The lid 20 is shown to be separated from the storage vessel 30 and bowl 16 assembly.

In FIG. 12, the lid 20 and storage vessel 30 are shown to be assembled to one another, whilst the bowl 16 is separated. In this configuration, the lid engagement members 50 are in engagement with the upper engagement members 40 of the storage vessel 30 such that the lid 20 is secured in placed relative to the storage vessel 30. It will thus be appreciated that the lid 20 and storage vessel 30 may together form a sub-assembly to allow the lid 20 and storage vessel 30 to concurrently be assembled to or removed from the bowl 16.

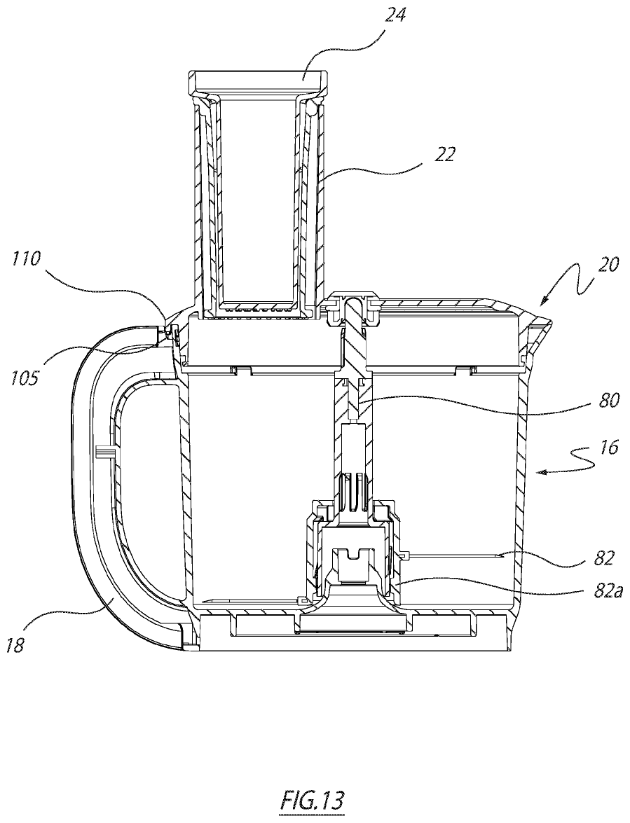

The storage vessel 30 may be disassembled and separated from the overall food processing device 10 assembly so as to place the food processing device 10 in the operating configuration, as best shown in FIG. 13. In this configuration, the storage vessel 30 has been removed and placed elsewhere away from the food processing device 10. In the depicted embodiment, only the first accessory (chopping blade) 82 is shown, as the food processing device 10 is being used for a chopping operation which does not require any of the other second, third or fourth accessories 84, 86 and 88. The second, third and fourth accessories 84, 86 and 88 will be understood to remain in storage in the separated storage vessel 30. It will be appreciated that for safety reasons, at least the first accessory (chopping blade) 82, which may be hidden from the user's view as it is located below a number of components, remains in the bowl 16 when the storage vessel 30 is disassembled and separated from the overall food processing device 10. That is the first accessory (chopping blade) 82 (which is mounted on the spindle 80 as described above) does not get removed with the storage vessel 30 during disassembly, thereby reducing the risk of the user contacting and injuring themselves on the otherwise exposed first accessory (chopping blade) 80. Additionally, as chopping blades are understood to be the most commonly used accessory in food processors, it will be appreciated that the placement and retention of the first accessory (chopping blade) 80 in the bowl 16 may at least allow for quick and repeated use of the first accessory (chopping blade) 80, thereby reducing the need to disassemble and reassemble multiple components prior to use.

FIG. 13 also depicts the operating configuration, in which the food processing device 10 is allowed to operate, as the absence of the storage vessel 30 allows the engagement of the lid 20 with the bowl 16. In this operating configuration, a lid interlock portion 100 of the lid 2, is in engagement with a handle interlock assembly 105 of the handle 18 of the bowl 16. The engagement of the lid interlock portion 100 and the handle interlock assembly 105 triggers a mechanical switch or linkage that communicates with a base interlock assembly 108 in the motorised base 12 (see FIG. 4), thereby permitting operation of the motorised base 12 (i.e. to drive rotation of the spindle 80 for a food processing operation). An example of the lid/handle interlock engagement is described in detail in the Applicant's earlier International Application No. PCT/AU2011/001578, filed on 7 Dec. 2011. In the interest of brevity, the entire content of this International Application is incorporated herein by cross-reference.

Returning to FIGS. 4, 4A and 6, it can be seen that the presence of the storage vessel 30 prevents the engagement of the lid interlock portion (tongue) 100 and the handle interlock assembly 105, thus preventing operation of the food processing device 10. This is a safety feature that prevents the food processing device 10 from being powered on whilst it is in the storage configuration (i.e. when the storage vessel 30 and/or the various accessories are present), or if the lid 20 is not engaged with the bowl 16. More particularly, and as best shown in FIGS. 4A and 6, the presence of the storage vessel 30 creates an air gap 110 between the lid interlock portion 100 and a cover portion 115 of the storage vessel 30. In the depicted embodiment, the cover portion 115 has a first arm 117 that extends transversely from the upper rim portion 36 and a second arm 119 that extends transversely from the first arm 117 in a generally upward direction. The second arm 119 is spaced from the upper rim portion 36. The air gap 110 as shown is provided between a bottom surface of the lid interlock portion 100 and an upper surface of the first arm 117. The transversely extending first arm 117 extends over and blocks an opening 120 of the handle interlock assembly 105 such that the lid interlock tongue 100 (or any other object) is unable to enter the opening 120 to trigger the handle interlock assembly 105, thereby preventing communication with the base interlock assembly 108 in the motorised base 12.

It envisaged that in other embodiments (not shown), the cover portion 115 of the storage vessel 30 may be in any other shape or configuration suitable for providing an air gap and/or to prevent access to the handle interlock assembly 105, and does not necessarily need to have a configuration that includes a first arm 117 and second arm 119 as depicted. A transition region 125 may also be provided from the bowl 16, to the storage vessel 30 and to the lid 20. It is envisaged that the transition region 125 may provide a visual continuation or bridge between a spout portion 130 of the bowl 16 and a spout cover portion 135 of the lid 20.

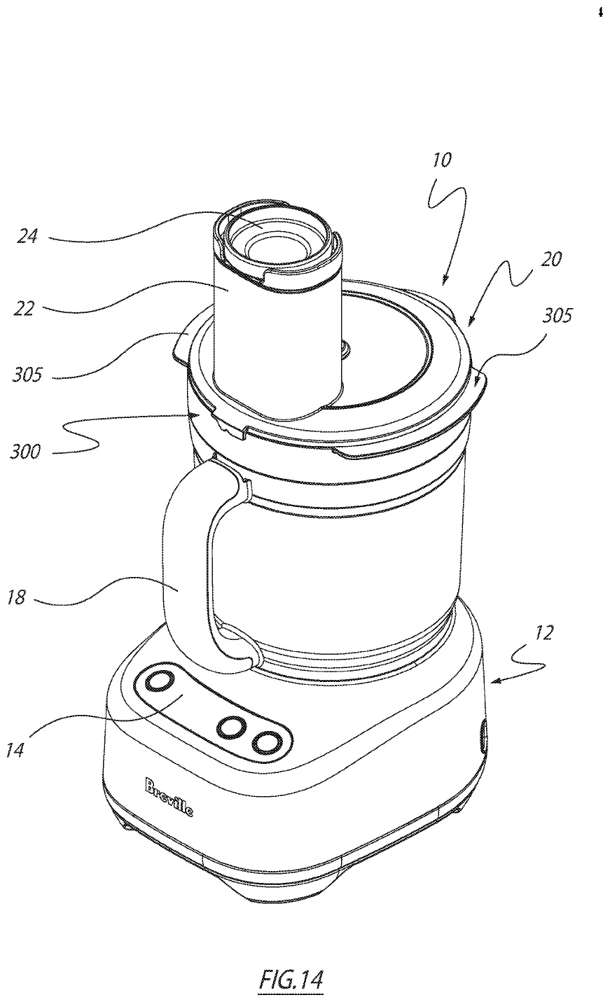

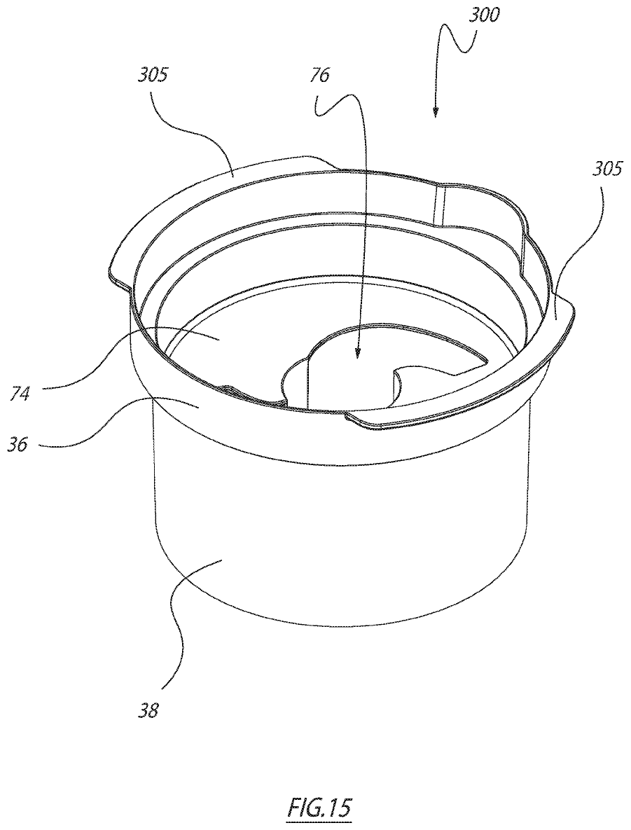

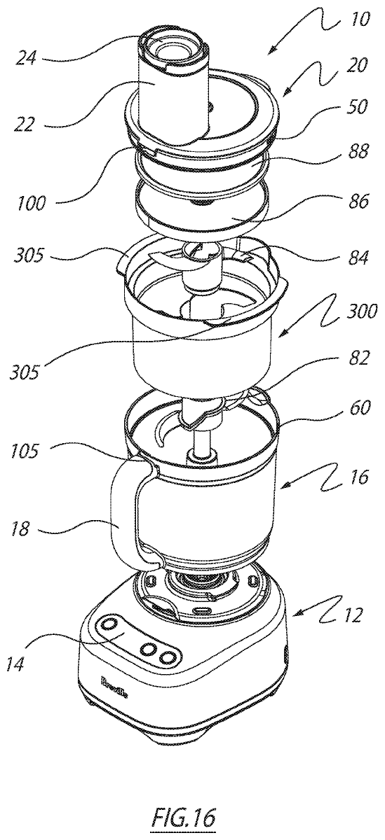

In FIG. 14 of the accompanying drawings, there is schematically depicted a food processing device 10 including an alternative embodiment of a storage vessel 300, which operates in generally the same manner as the storage vessel 30 described above, with like reference numerals being used to indicate like features. However, in this embodiment and as best shown in FIGS. 15 and 16, the upper rim portion 36 of the storage vessel 300 does not include the upper engagement member(s) 40 described above in relation to the storage vessel 30. Instead, the storage vessel 300 includes at gripping member 305 that extends transversely from the upper rim portion 36. In the depicted embodiment, the upper rim portion 36 includes a pair of gripping members in the form of tabs 305. It will be appreciated that in other embodiments (not shown), the upper rim portion 36 may be provided with any number of gripping member(s) 305, which may alternatively be in the form of any feature suitable for a user to grip. The gripping member(s) 305 may also be located anywhere on the upper rim portion 36. This embodiment of the storage vessel 300 may also include the air gap 110 of the interlock configuration as described above in respect of FIG. 13.

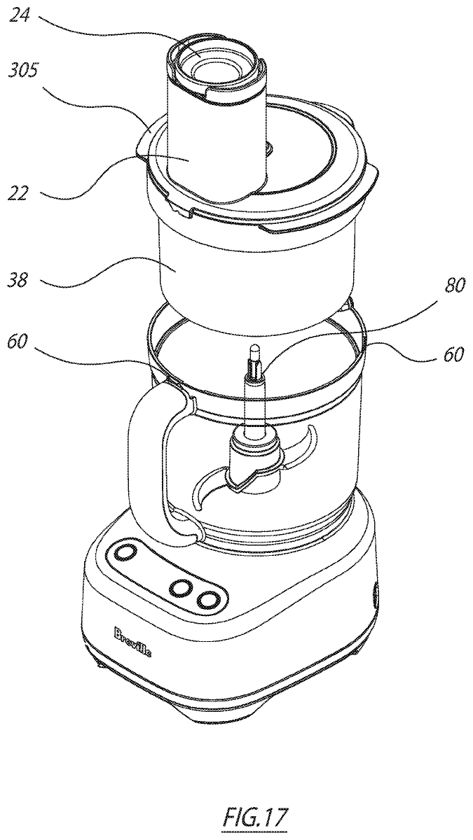

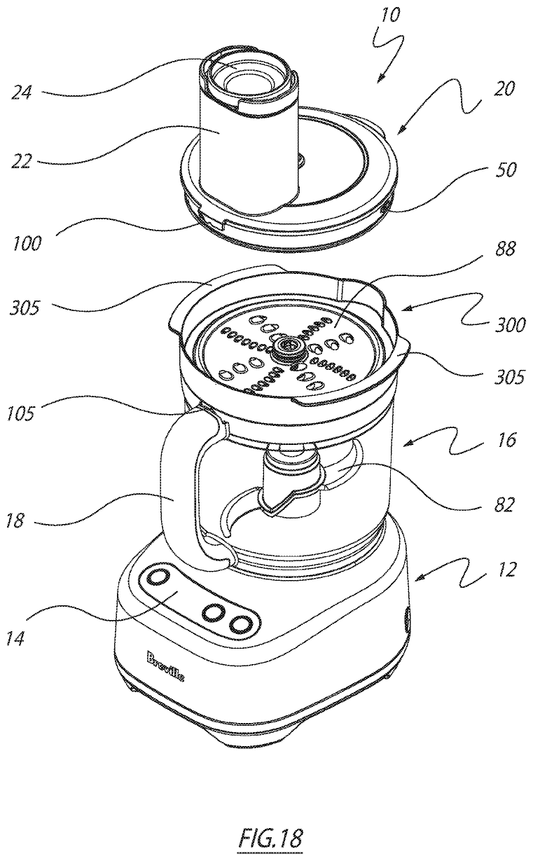

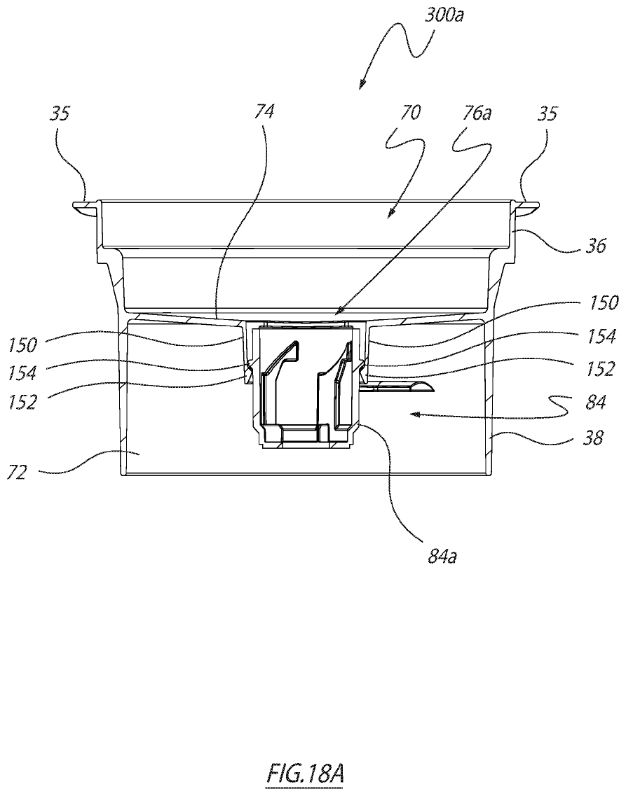

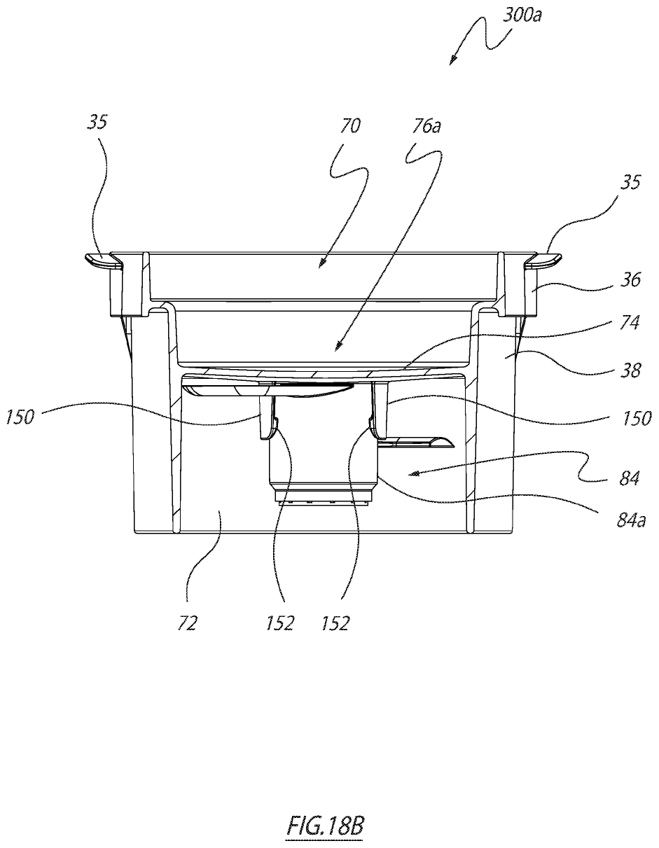

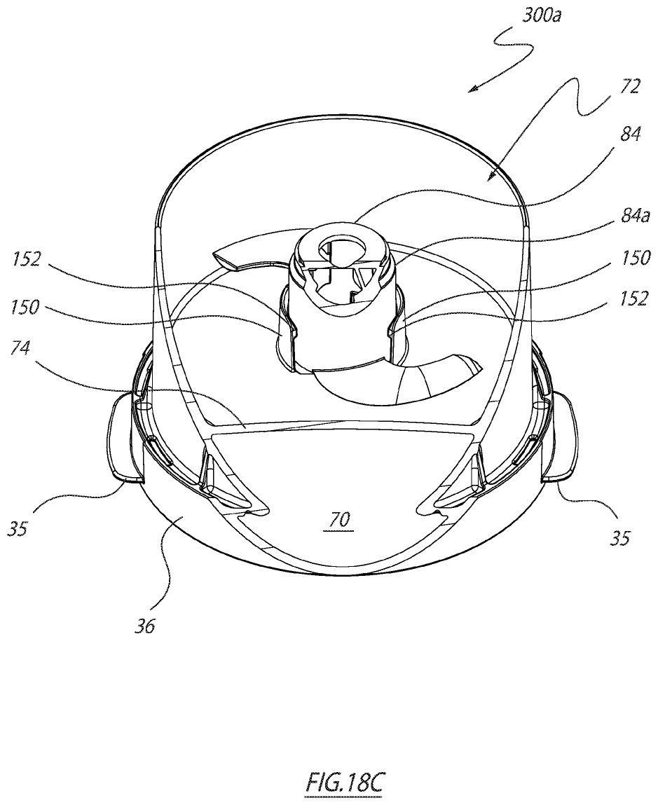

In this embodiment, the storage vessel 300 does not necessarily need to be secured or locked in place relative to either one of the lid 20 or the bowl 16. Whilst the lid 20 and the bowl 16 still include the respective lid engagement members 50 and bowl engagement members 60 such that the lid 20 and the bowl 16 may be secured or locked in placed relative to one another, it will be appreciated that the storage vessel 300 may simply rest between the lid and the bowl 16 in the storage configuration. To dissemble the storage vessel 300 from the food processing device 10, the user may simply lift the storage vessel 300 away from the bowl 16 using the gripping member(s) 305. The lid 20 which is resting on the storage vessel 300, is removed at the same time. This method of disassembly is best shown in FIG. 17. Alternatively, the user may first lift the lid 20 from the overall food processing device 10 assembly as shown in FIG. 18, and subsequently remove the storage vessel 300 (along with the various accessories that are stored therein) using the gripping member(s) 305.

It will be appreciated that in other embodiments (not shown), a storage vessel may be provided which includes both the upper engagement member(s) 40 described above in relation to the storage vessel 30 in addition to the gripping member(s) 305 described above in relation to the storage vessel 300.

FIG. 18A to 18C show another embodiment of the storage vessel 300A. FIG. 18A is a section view though the central axis of the storage vessel 300A showing the second accessory (dough blade) 84 detachably held in the lower cavity 74. This form of the storage vessel 300A has opposed grip tabs 150 depending from the underside of the partition 74. Each grip tab 150 has an inward lip 152 for snap-locking engagement with external ridges or bumps 154 formed on the exterior of the dough blade hub 84a.

FIG. 18B is a section view through a vertical plane offset from the central axis to show the grip tabs 150 are curved to correspond with the sides of the dough blade hub 84a. Furthermore, the axial length of the grip tabs 150 is less than that of the dough blade hub 84a which is a helpful indication to users that they are intended to receive and retain the dough blade 84 and provides enough of the hub 84a for the user to grip when pushing the external ridges 154 into detachable engagement with the inward lips 152, or pulling the hub 84a out from between the inward lips 152.

FIG. 18C shows the storage vessel 300A upside down, and is sectioned through a plane skewed to the central axis. This perspective shows that the aperture 76A though the partition 74 is not shaped to correspond with the plan profile of the dough blade 84, this form of the storage vessel 300A only needs a partition aperture 76A that allows the spindle (not shown) to pass through. This form of the storage vessel 300A may appear less complex for some users when assembling and nesting the accessories together for storage.

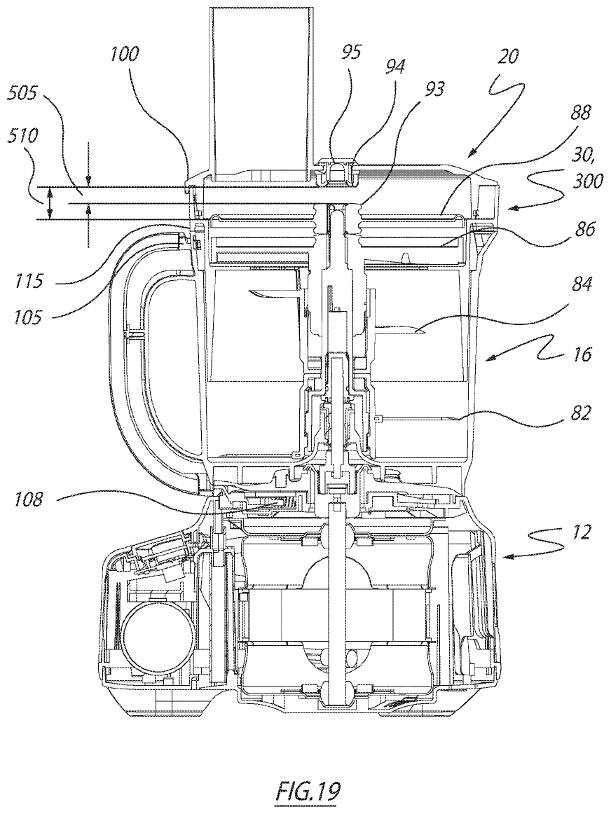

In FIG. 19, there is depicted an alternative embodiment of the food processing device 500, which operates in generally the same manner as the food processing device 10 described above, with like reference numerals being used to indicate like features. However, in this embodiment, a larger first air gap 505 is provided between the top surface 93 of the hub 88a of the fourth accessory (shredding disk) 88 and the lid 20. More particularly, the first air gap 505 is provided between the top surface 93 and the bottom surface 94 of the bushing 95 in the lid 20. It will be appreciated that this larger first air gap 505 in turn increases the size of an air gap 510 between the lid interlock portion 100 and a cover portion 115 of the storage vessel 30 or 300. As can be seen in FIG. 19, at least a portion of an inner wall of the lid 16 and/or the storage vessel 30 or 300 has an increased height to facilitate the increased height of the air gaps 505 and 510. It will be appreciated that the increased height of the air gaps 505 and 510 is provided to accommodate a circumference of the fourth accessory (shredding disk) 88 and/or the third accessory (adjustable slicer) 86, which may at least prevent horizontal movement of the fourth accessory (shredding disk) 88 and the third accessory (adjustable slicer) 86 in the storage vessel 30 or 300 when removed from the bowl 16. As discussed above in relation to the air gaps 90 and 92, the arrangement of the air gaps 505 and 510 may at least reduce or eliminate wear and tear to the third and fourth accessories 86 and 88, for example, from repeated assembly/disassembly of the various parts, and also during transportation of the food processing device 10.

Various forms of the food processing devices and storage vessels described above may have one or more of the following advantages. For example, the arrangement of the storage vessel may at least facilitate safe and space-efficient storage for the various accessories when the food processing device is not in use. The stackable/nestable configuration of the accessories, together with the arrangement of the storage vessel, creates a compact assembly that is designed to reduce the need to increase the overall height of the food processing device. The stackable/nestable configuration of the accessories may also allow the user to concurrently remove the storage vessel with the accessories, which eliminates the need for the user to remove and handle each individual accessory separately.

The storage vessel may also be used to store the various accessories in one storage configuration in which the storage vessel is assembled to the food processing device, or in an alternative storage configuration in which the storage vessel is located separately to the food processing device.

The interlock arrangement of the lid, storage vessel and bowl described above may also prevent accidental activation of the food processing device whilst in the storage configuration, thus providing an additional safety feature. As described above, operation of the motorised base of the food processing device is prevented when the storage vessel is present. The presence of the storage vessel creates a sufficiently large gap or space between the lid interlock and the handle interlock, thus ensuring that the associated base interlock assembly of the motorised base cannot be activated whilst the storage vessel is physically assembled in place.

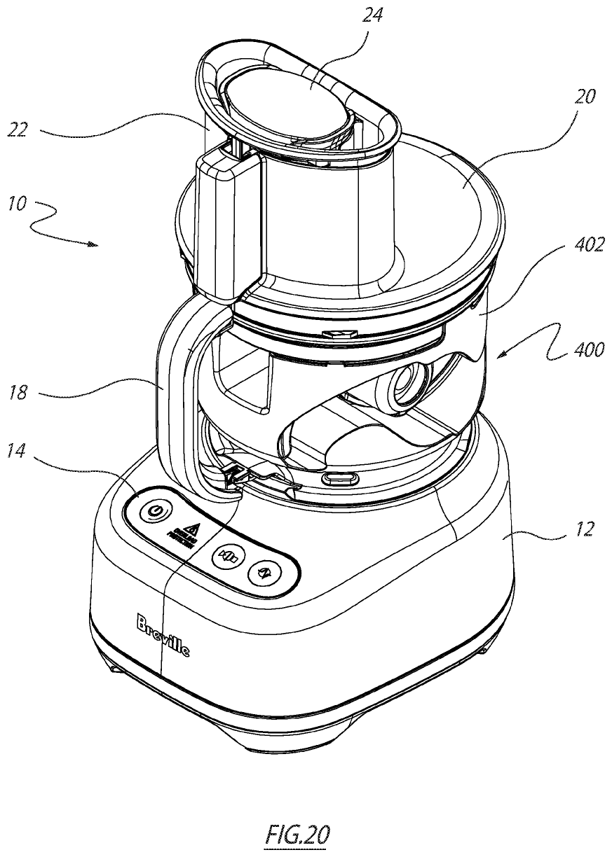

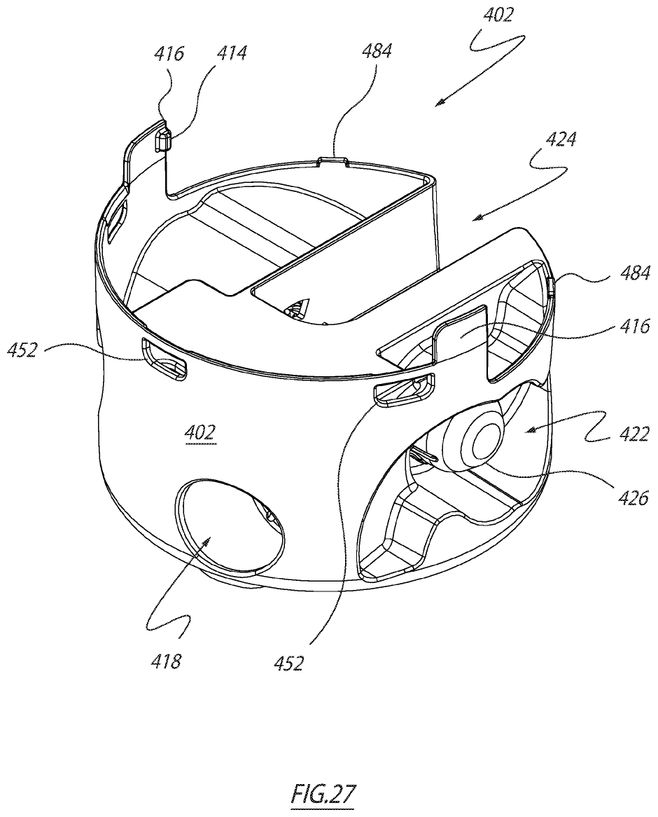

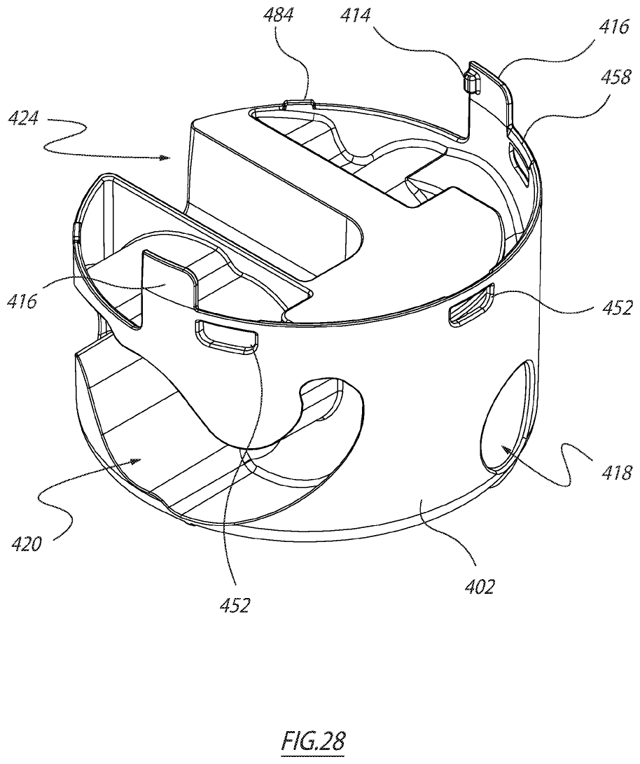

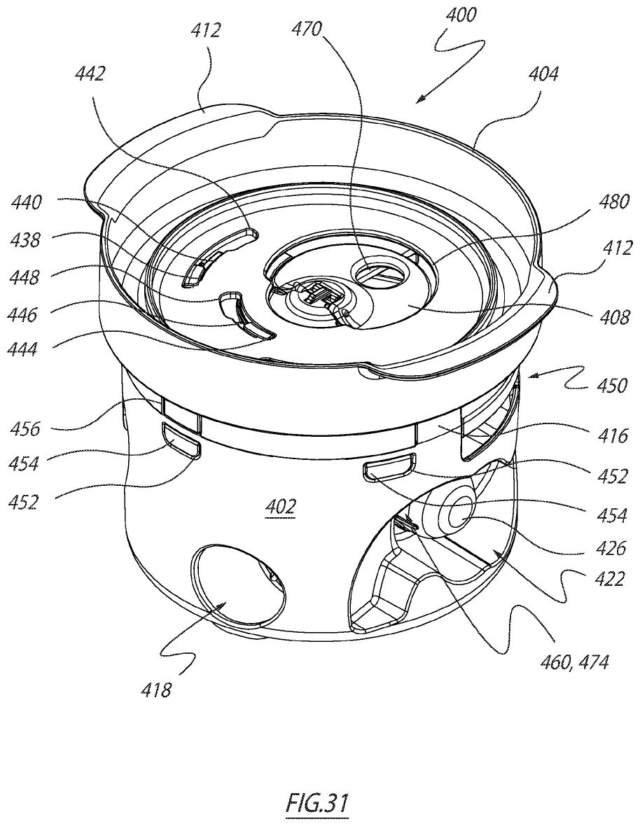

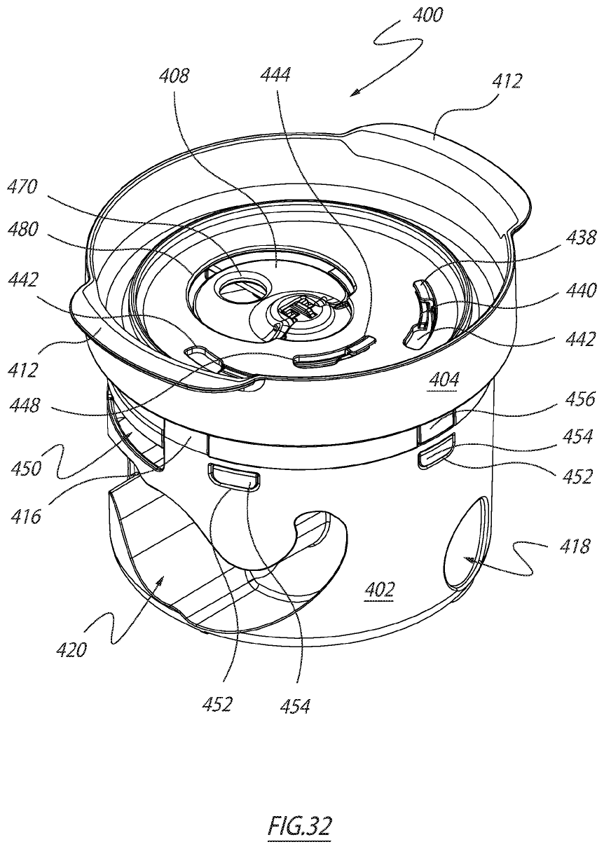

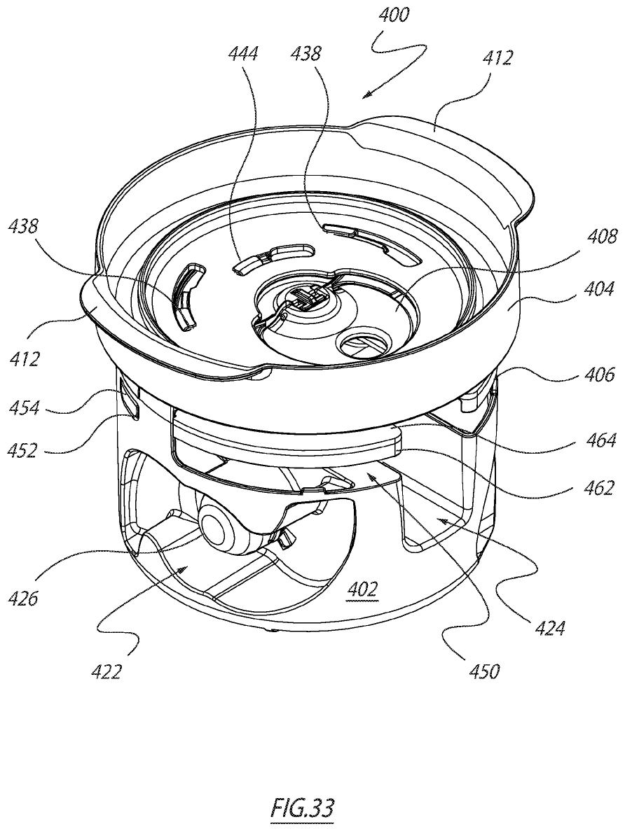

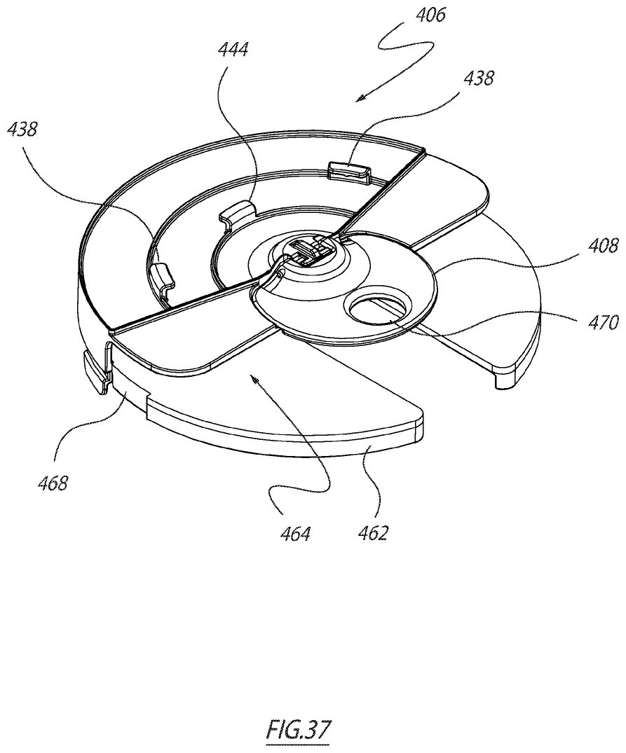

FIGS. 20 to 48 show two embodiments of a storage structure 400 for the accessories or a food processor 10. The storage structure 400 provides compact and safe storage of the accessories by allowing the user to individually select and remove (or replace) any of the stored accessories, without first removing or otherwise handling any of the other accessories. This avoids unnecessary contact with accessories with sharp blades to reduce the risk of injury.

Referring to the Figures, a food processor 10 is shown in FIG. 20 with the processing bowl 16 removed to show a storage structure 400 according to a first embodiment housed therein.

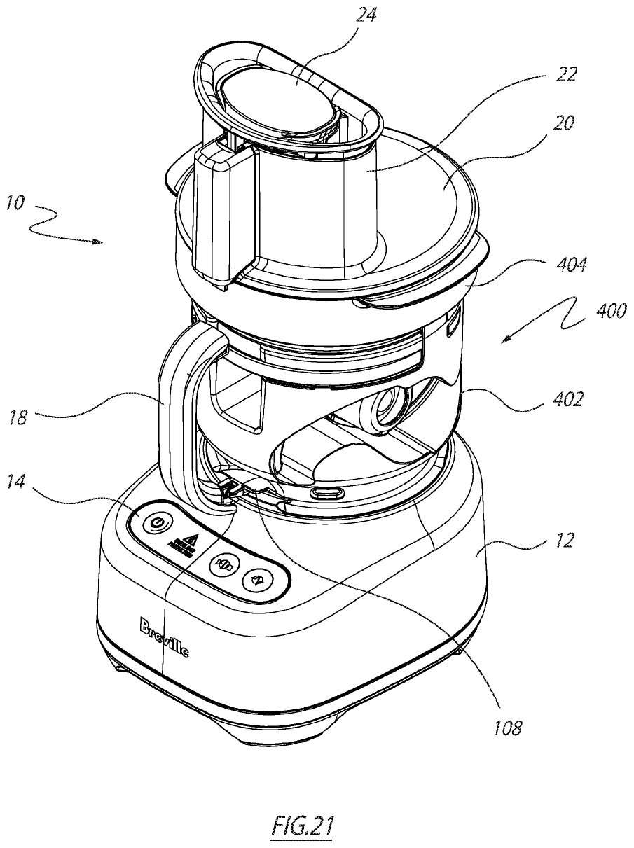

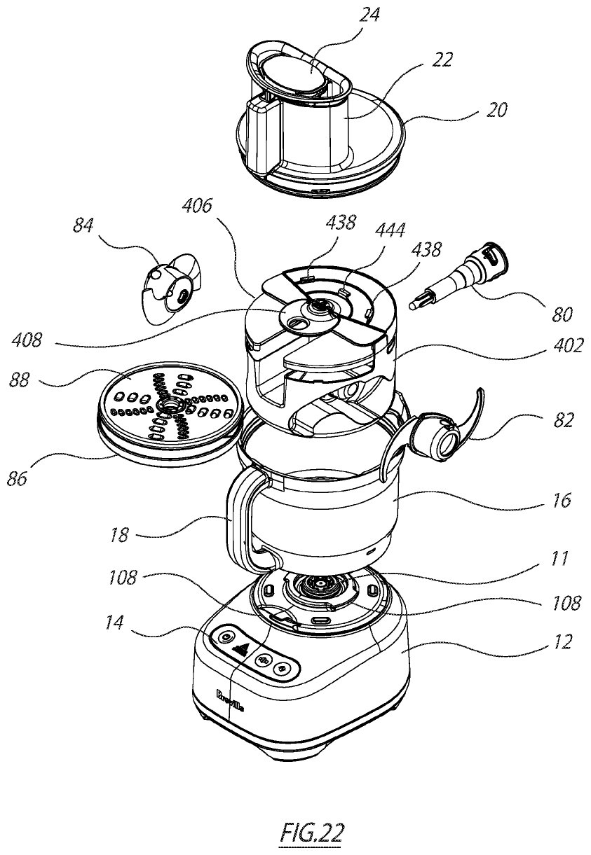

The food processor 10 has a motorised base 12 with a user interface 14 to facilitate control of the device. As best shown in FIG. 22, the food processor 10 includes a processing bowl 16 that detachably secures to the motorised base 12 via a base interlock assembly 108. The base interlock assembly includes complementary features on the top of the motorised base 12 and the bottom of the bowl 16. The user grips the handle 18 to manually rotate the bowl relative to the motorised base 12 to release or engage the base interlock assembly 108.

The top of the bowl 16 is closed with a lid 20 having a feed tube 22 for safely inserting food into the bowl 16. A pusher 24 may be inserted into the feed tube 22 to force the food into the bowl and to discourage the user from manually pushing food through the tube 22 with fingers.

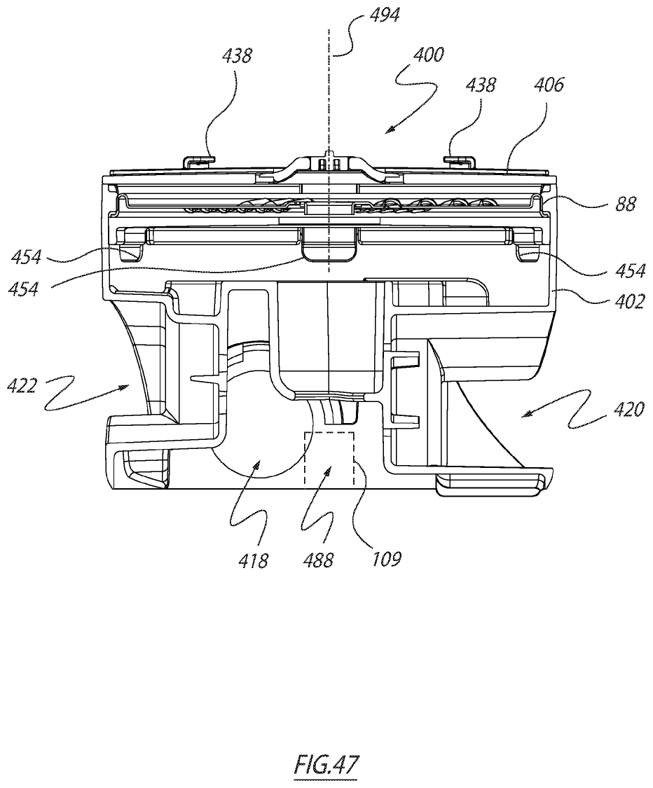

A spindle drive coupling 109 (see FIG. 47) protruding from the base of the bowl 16 engages the drive socket 11 in the top of the motorised base 12. The drive socket 11 mates with lower end of the spindle drive coupling 109 while the upper end within the bowl 16 is configured to detachably engage the spindle 80. The spindle 80 detachably engages the various food processing accessories (e.g. 82, 84, 86 and 88 described below) for rotation within the bowl during the associated food processing operation.

FIGS. 20 and 22 depict a first embodiment of the storage structure 400 which can hold four separate processing accessories (82, 84, 86 and 88) as well as the spindle 80. The storage structure 400 according to the first embodiment can fit completely within the bowl 16 such that the lid 20 can engage the bayonet features of the bowl 16 in the usual manner. This provides storage of the various food processing accessories as well as the spindle 80 in a secure manner with the sharp blade edges prevented from damaging contact with each other or the bowl itself. The storage structure 400 has a base unit 402 moulded from high wear systems material such as Triton® or SAN (Triton® is a BPA free (bisphenol A free) plastic marketed by Eastman Chemical Company of the United States). SAN is the common name for the copolymer plastic, styrene acrylonitrile.

A base unit cover 406 is attached to the top of the base unit 402 such that the storage structure 400 provides slots for the adjustable slicing disk 86 and the shredding disk 88 (described in greater detail below). The cover 406 also includes a hinged lift handle 408 allowing the entire storage structure 400 to be removed from within the bowl 16 without requiring the user to touch any of the stored accessories 82, 84, 86 or 88. This avoids the risk of injury to the user through inadvertent contact with any of the sharp blades used on the processing accessories. Furthermore, as will be discussed in greater detail below, each of the accessories 82, 84, 86 and 88 may be individually removed from the storage structure 400 without first needing to remove any of the other accessories. This also reduces the risk of harmful contact with sharp portions of the accessories as well as potentially unhygienic contact with accessories that are handled merely for the purpose of accessing another accessory within the storage structure 400.

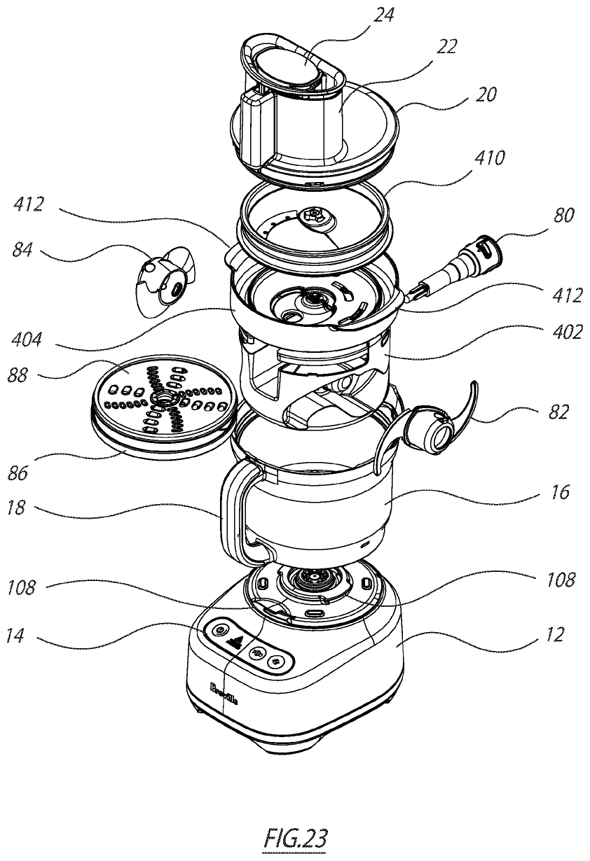

A second embodiment of the storage structure 400 is shown in FIGS. 21 and 23. The second embodiment of the storage structure 400 includes an additional unit 404 that can detachably engage the base unit cover 406 to provide storage for another accessory such as a dicing kit 410. It will be appreciated that this provides options for the user to purchase the food processor 10 with just the more commonly used accessories 82, 84, 86 and 88, or with more specialised accessories such as the dicer kit 410. The additional accessory is securely stored together with the other accessories in a storage structure with the additional unit 404. Furthermore, the additional unit 404 may be a subsequent purchase together with the dicing kit 410 and easily incorporated into the user's existing food processor 10 and storage structure 400. Importantly, the second embodiment of the storage structure 400 still allows the user to individually select any of the food processing accessories, including the dicing kit 410 without first removing any of the other accessories from the storage structure.

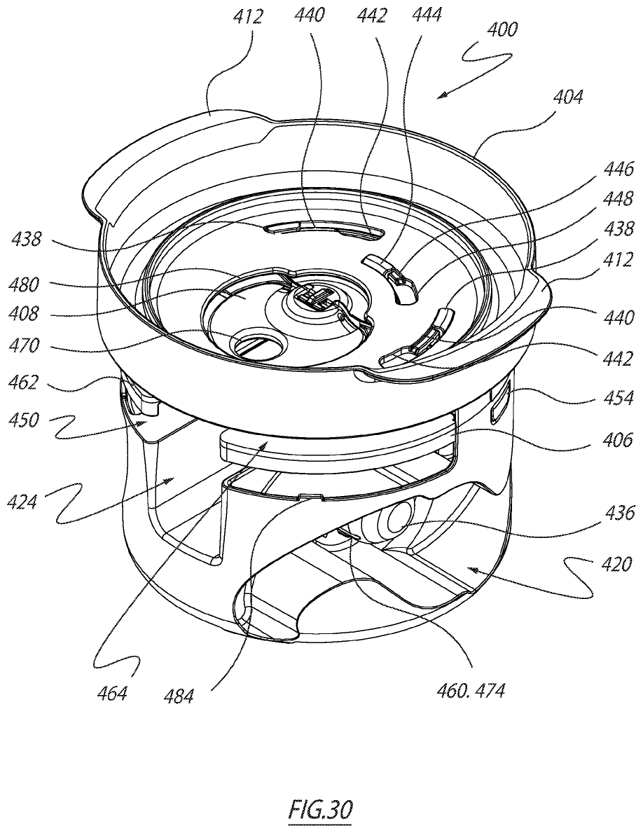

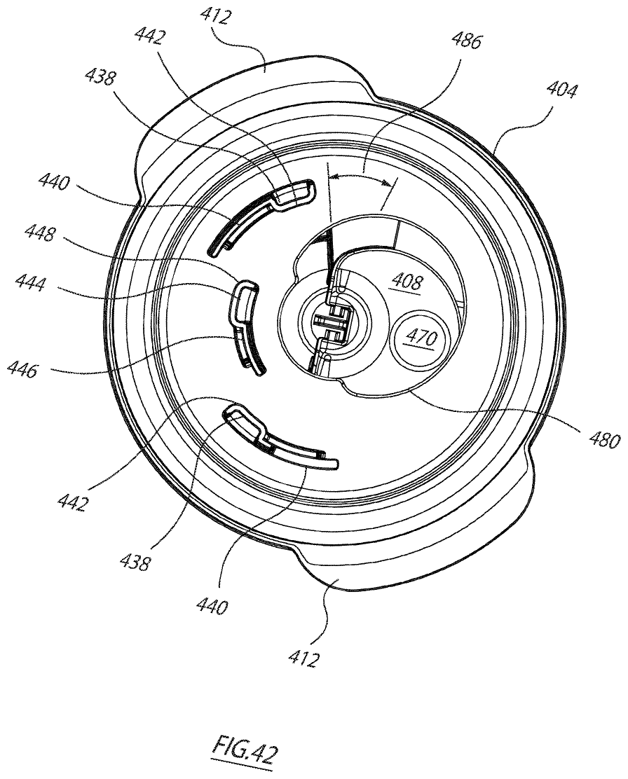

The additional unit 404 detachably engages the top surface of the base unit cover 406 using complementary bayonet features. The bayonet features allow relative rotation between the cover 406 and the additional unit 404 between locked and unlocked positions described in greater detail below with reference to FIGS. 30 and 42. However, as shown in FIG. 23, the additional unit 404 adds to the height of the storage structure 400 such that it no longer completely fits within the bowl 16. In light of this the lid 20 may be placed onto the open top of the additional unit 404 rather than engage the bowl 16 in the usual manner. However, the storage structure 400 according to the second embodiment may still be removed from the food processor bowl 16 without requiring the user to touch any of the stored accessories. The additional unit 404 has diametrically opposed, lift tabs 412 allowing the user to simply lift the storage structure 400 clear of the food processor bowl 16. Having removed the entire storage structure 400 from the food processor 10, individual accessories may be selected and removed from the storage structure 400, including the dicing kit 410 from the open top of the additional unit 404.

Similar to the storage vessel 30 described above with reference to FIGS. 4, 4A, 6 and 13, the presence of the additional unit 404 prevents engagement of the lid interlock portion and the handle interlock assembly, which in turn prevents activation of the motorised base 12.

FIGS. 24 and 25 are vertically sectioned views through the first and second embodiments of the storage structure 400 respectively.

FIG. 24 is a section view through the first embodiment of the storage structure 400 showing the rear half as viewed from the front in the frame of reference provided by FIG. 20. The base unit 402 has recesses 420 and 422 formed on opposing sides. The chopping blade recess 420 has as the chopping blade 82 retained on the chopping blade mount 436. The dough blade recess 422 accommodates the dough blade 84 retained on the dough blade mount 426. In the rear of the base unit 402 is an aperture 418 to hold the spindle socket 472. The spindle socket 472 has opposed gripping features 476 to detachably retain the spindle 80.

Above the base unit 402 is the cover 406. The connection between the cover 406 and the base unit 402 is described in greater detail below. However, the cover 406 and the base unit 402 together provide an adjustable slicer slot 450 and a shredding disk slot 464 to retain the adjustable slicing disk 86 and the shredding disk 88 respectively. The adjustable slicing slot 450 is separated from the shredding disk slot 464 by the partition 462. The partition 462 maintains separation between the adjustable slicing disk 86 and the shredding disk 88 during storage.

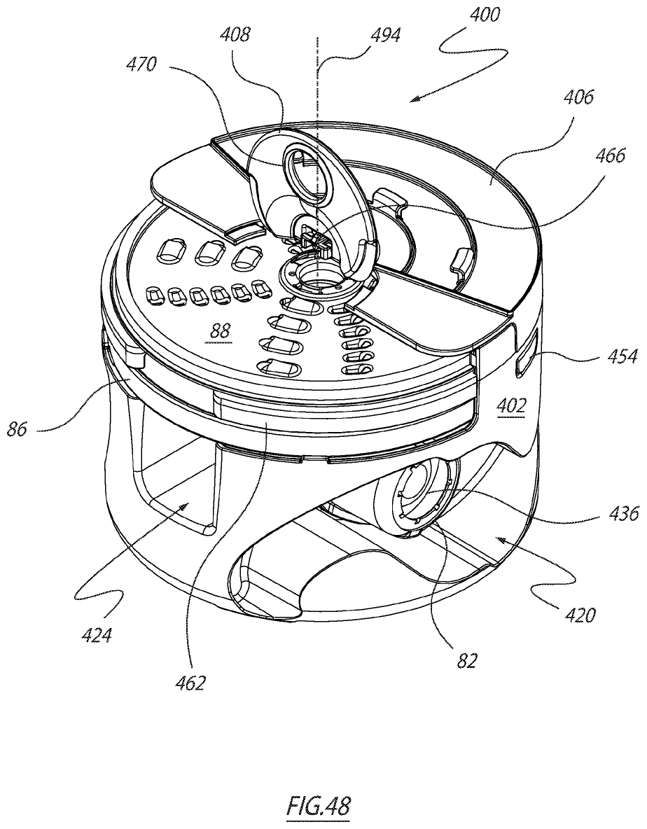

In the centre of the cover 406 is the hinged handle 408. The handle 408 rotates to an upright orientation (see FIG. 48) allowing the user to lift the first embodiment of the storage structure 400 out of the bowl 16 without needing to touch any of the accessories 82 to 88 or the spindle 80. Furthermore, with the storage structure 400 removed from the bowl 16, each of the accessories 82 to 88 are individually accessible to the user without first needing to remove any of the other accessories to gain access. Likewise, the spindle is individually accessible without needing to remove or handle other accessories. Conversely each of the accessories are individually replaceable back into the storage unit 400 without first placing any other accessory or the drive spindle 80 back in the storage structure.

FIG. 25 is a vertically sectioned view of the second embodiment of the storage structure 400 showing the front half being viewed from the rear from the frame of reference of FIGS. 21 and 23. The second embodiment of the storage structure 400 has the additional unit 404 attached to the top of the cover 406. The additional unit 404 provides a storage pocket for an additional accessory such as a dicing kit 410. Dicing kits 410 are used for dicing or cutting hard starchy vegetables such as potatoes, turnips and sweet potatoes into chips. Some users may not require the dicing or chipping functionality from the food processor. In this case, the food processor can be purchased with the first embodiment of the storage structure 400 together with the more frequently used accessories 82 to 88. The additional unit 404 and the dicing kit 410 is an option for those requiring this functionality.

The second embodiment of the storage structure 400 still allows the user to individually access each of the accessories 82 to 88 and the dicing kit 410 without first needing to remove another of the accessories. The dicing kit 410 may be removed from the open top of the additional unit 404 while the attachment of the additional unit 404 does not impede access to the shredding disk 88 or the adjustable slicing disk 86. Furthermore, the additional unit 404 is provided with laterally extending lift tabs 412 for the user to lift the storage structure 400 out of the bowl 16 (see FIG. 23) with minimal risk of touching any of the stored accessories. Conversely the storage structure 400 is placed back into the processing bowl 16 using the lift tabs 412 without needing to physically touch any of the food processing accessories 82 to 88, spindle 80 or the dicing kit 410.

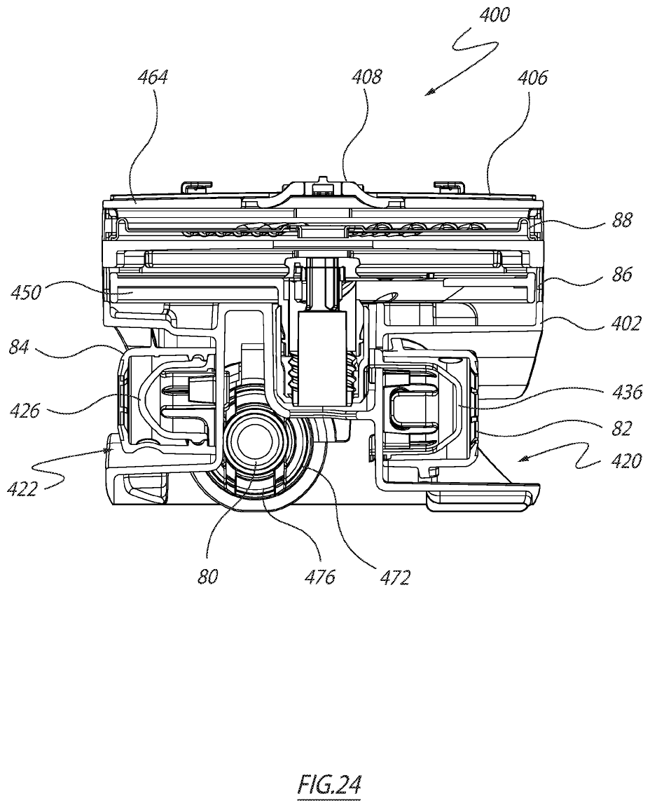

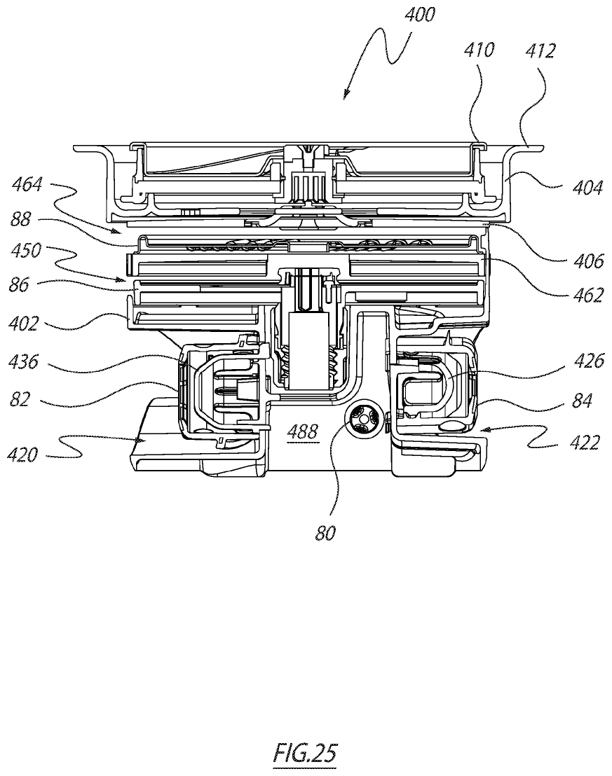

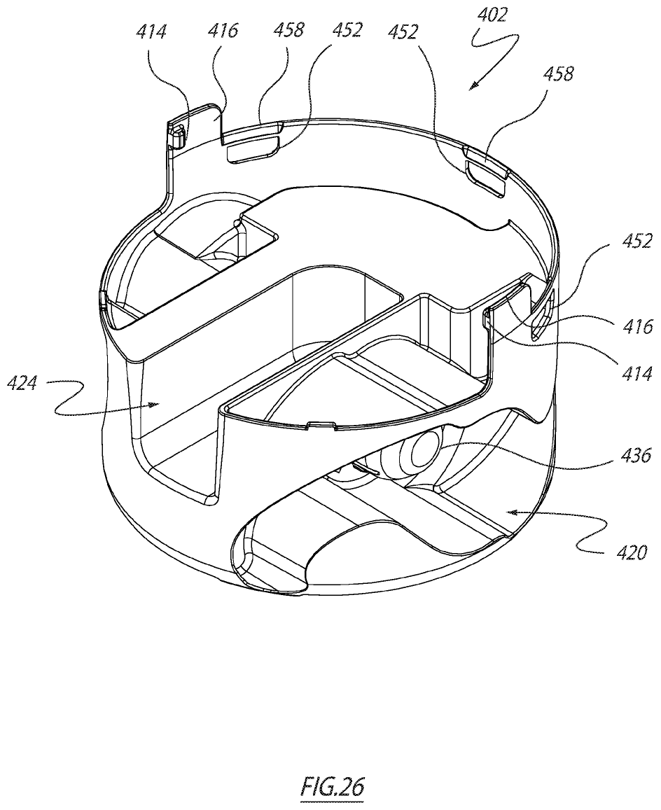

FIGS. 26 to 29 show the base unit 402 from different perspectives to depict the location of the dough blade mount 426 and the chopping blade mount 436 within the dough blade recess 422 and the chopping blade recess 420 respectively. The chopping blade recess 420 and the dough blade recess 422 retain the chopping blade 82 and the dough blade 84 such that the sharp edges are within the peripheral extent of the base unit 402. This provides a protective guard against inadvertently touching the sharp edges of these accessories for the user safety. The shape of the recesses 420 and 422 corresponds to the respective accessory, which gives a clear indication for the user to access/replace the accessory at correct locations.

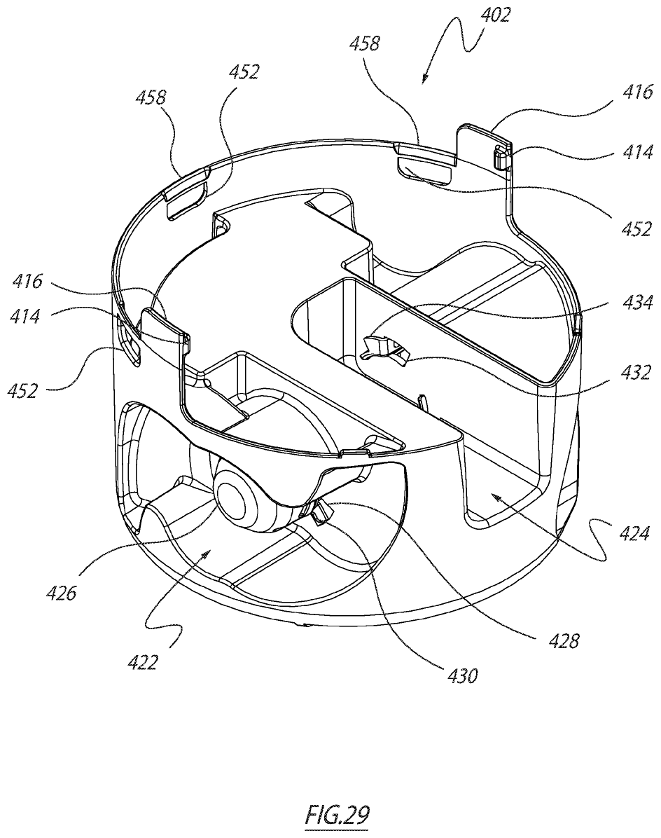

The chopping blade 82 and the dough blade 84 are detachably retained in the correct position within the chopping blade recess 420 and the dough blade recess 422 respectively by the chopping blade mount 436 and dough blade mount 426. As best shown in FIG. 29, the base unit 402 has a chopping blade recess aperture 432 for receiving and engaging with the chopping blade mount bayonet tab 434. While only one aperture 432 and bayonet tab 434 are show in FIG. 29, it will be appreciated that multiple tabs and complementary apertures are provided to securely connect the chopping blade mount 436 within the chopping blade recess 420.

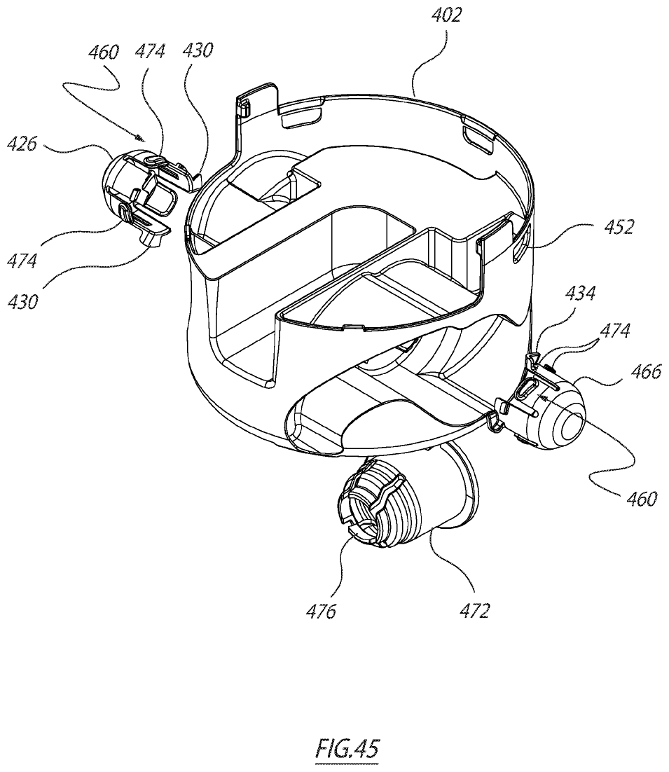

Similarly, the dough blade recess 422 has dough blade recess apertures 428 for receiving and engaging with the dough blade mount bayonet tabs 430. Both the dough blade mount 426 and the chopping blade mount 436 can be detached from the base unit 402 for cleaning if necessary and easily replaced via the bayonet connection. The accessory mounts 426 and 436 also include engagement features 474 discussed in greater detail below with reference to FIG. 45. The mounts 426 and 436 use the engagement features to detachably retain the chopping blade 82 and dough blade 84 via an interference fit allowing the user to manually remove the accessory from the respective recess while also securely retaining the accessory within the respective recess during storage.

At the top of the base unit 402 are upper extensions 416 that each support an inwardly extending capture bump 414 to resiliently retain the shredding disk 88 in the shredding disk slot 464. The inward facing capture bumps 414 are both positioned slightly forward of the diameter extending through the upward extensions 416 such that the shredding disk 88 engages both the capture bumps 414 as it is inserted into the shredding disk slot 464 just prior to the widest point (i.e. a diameter of the disk). A degree of flexibility in the upward extensions 416 allows the shredding disk 88 to be pushed through the capture bumps 414 past the widest point provided by the diameter to a position just past the diameter to retain the disk in the slot via what is effectively an over centre mechanism.

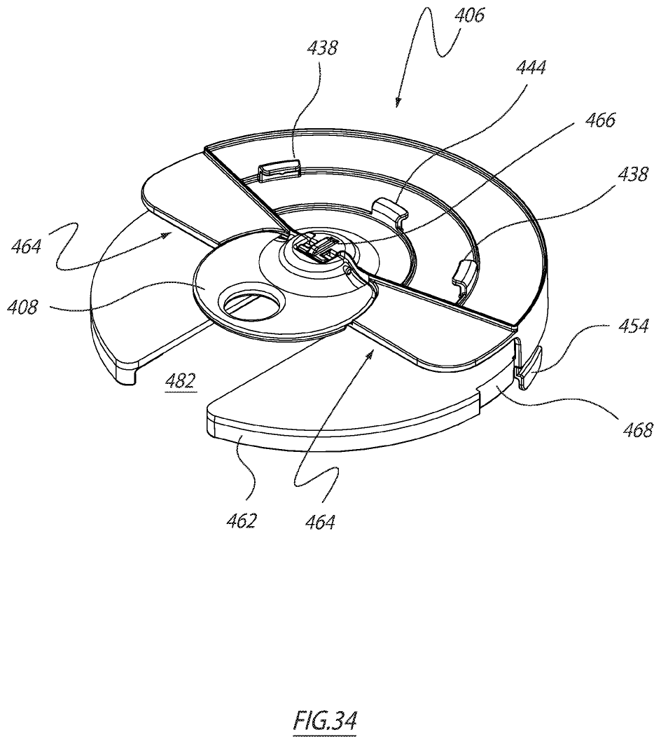

The top of the base unit 402 also has side wall apertures 452 formed in the side wall directly beneath guide ramps 458 formed in the top rim of the side wall. These features are used in the snap-locking interconnection between the base unit 402 and the cover 406. This snap-lock connection is discussed in greater detail below with reference to FIGS. 34 to 37. At the front of the base unit 402 is a finger access recess 424 extending between the chopping blade recess 420 and the dough blade recess 422. The finger access recess 424 allows the user to easily access and retrieve the adjustable slicing disk 86. As discussed below with reference to FIGS. 34 to 37, a gap in the partition 462 separating the shredding disk and the adjustable slicer provides finger access to the top side of the adjustable slicing disk 86 for the user to grip and draw it from the adjustable slicer slot 450.

FIGS. 30 to 33 are different perspectives of a storage structure 400 according to the second embodiment with the additional unit 404 in the locked position on the cover 406 of the base unit 402. The additional unit 404 connects to the top surface of the base unit cover 406 via a bayonet connection provided by the inwardly bent tabs 438, the outwardly bent tab 444 and the arcuate slots 440 and 446. The inwardly bent tabs 438 engage the two long arcuate slots 440 positioned at a greater radial distance from the centre of the additional unit 404 than the shorter arcuate slot 446. By relative rotation of the additional unit 404 and the cover 406, the inwardly bent tabs 438 and the outwardly bent tab 444 move to the other end of the slots 440 and 446. This position is an unlock position (see FIG. 42) allowing removal of the additional unit 404 from the cover 406 when the inwardly bent tabs 438 align with the inward tab opening 442 and the outwardly bent tab 444 aligns with the outward tab opening 448.

The additional unit 404 incorporates a handle access opening 480 that aligns with the lift handle 408 when in the locked position. In the event the dicing kit 410 is not in the additional unit 404 and the user chooses to lift the storage structure 400 via the hinged lift handle 408, the handle access opening 480 allows access to the finger hole 470 and rotation of the handle 408 to the upright orientation (see FIG. 48).

FIGS. 34 to 37 show different perspectives of the cover 406 for the base unit 402. The top of the cover 406 is provided with the inwardly bent tabs 438 positioned at a greater radial distance from the centre of the cover than the outwardly bent tab 444. Proximate the centre of the cover 406 is the hinge connection 466 for the lift handle 408. At the bottom of the cover 406 is a partition 462 for separating the adjustable slicer slot 450 and the shredding disk slot 464. As previously discussed, the partition 462 includes a gap 482 at the front to align with the finger access recess 424 in the base unit 402 so that the user can grip the rim of the adjustable slicing disk 86 (when stored in the adjustable slicer slot 450, see FIG. 11).

On the left and right sides of the cover 406 are peripheral locating recesses 468. When the cover 406 moves into snap locking engagement with the base unit 402 the upper extensions 416 on the top of the base unit 402 (see FIG. 26) extend through the peripheral located recesses 468 such that the inward facing capture bumps 414 are positioned within the shredding disk slot 464.

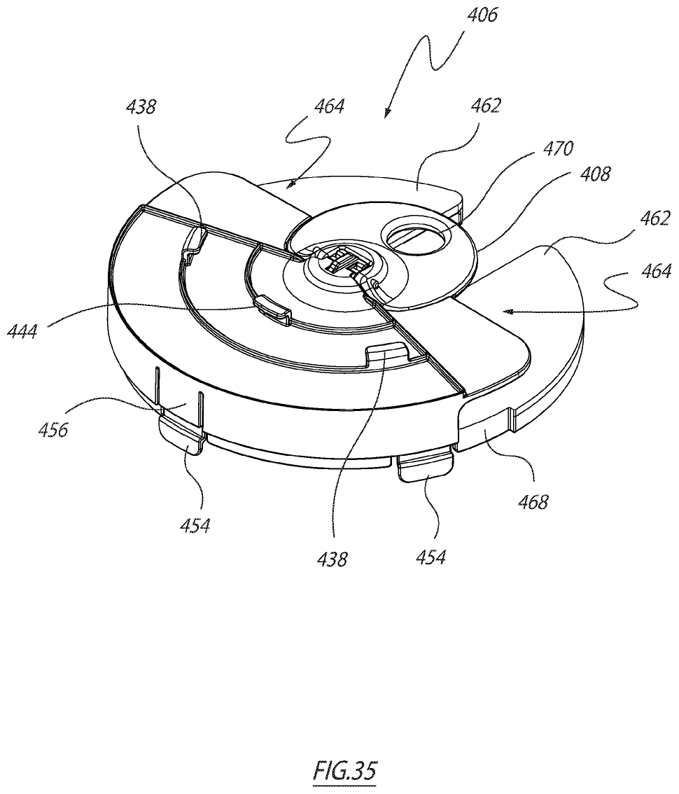

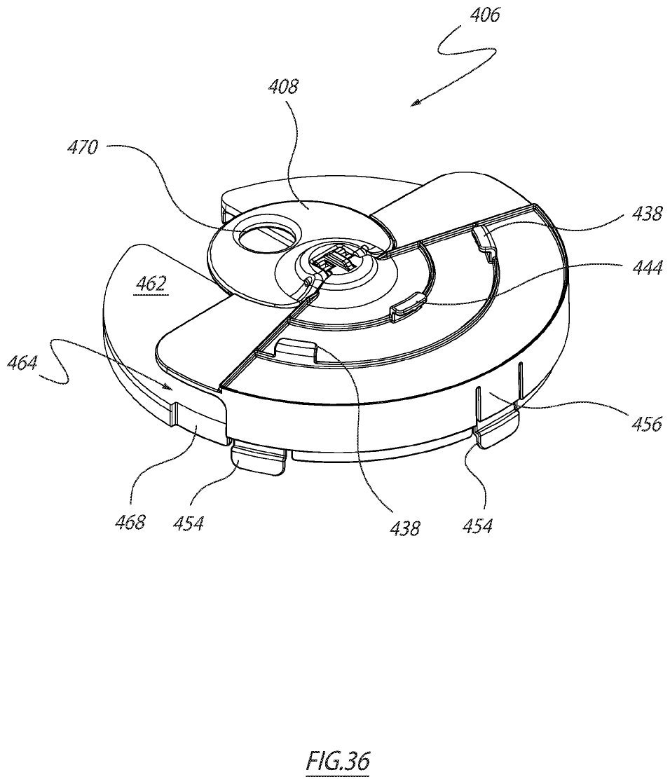

As best shown in FIGS. 35 and 36, the rear, lower periphery of the cover 406 includes downwardly extending snap locking tabs 454. For increased flexibility, the middle snap locking tab 454 is mounted to a flexible base section 456. The snap locking tabs 454 are positioned to engage the guide ramps 458 in the top rim of the base unit 402 (see FIG. 26). As the cover 460 is pushed downwards, the snap locking tabs 454 slide down the guide ramps 458 and eventually snap lock into the side wall apertures 452. Alternatively, the cover 406 may be permanently/integrally attached to the base unit 402.

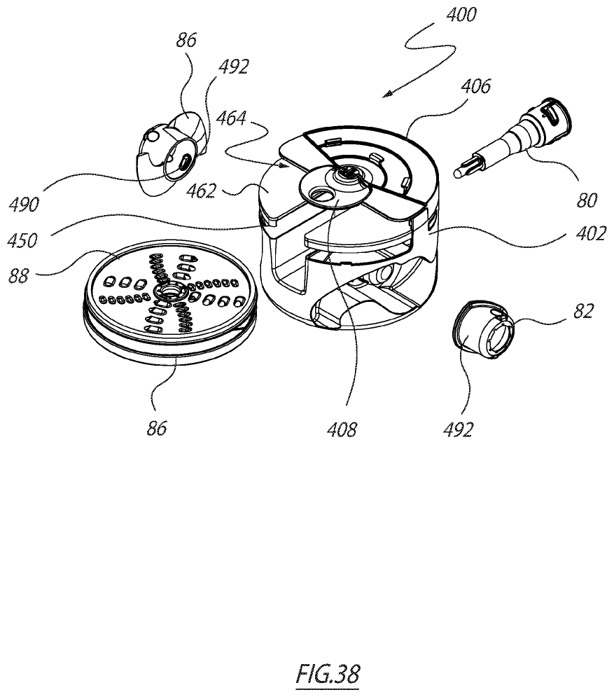

FIG. 38 shows the first embodiment of the storage structure 400 with the various accessories separated away from their respective storage positions. This depicts how the chopping blade 82 is individually accessible from the right side of the storage structure 400 (from the perspective shown in the figures), the dough blade 84 is accessible from the left side, the adjustable slicing disk and the shredding disk 86 and 88 may be individually drawn out from the front of the slots 450 and 464 respectively while the spindle 80 is retrieved from the rear of the storage structure 400. In this way, the user is not required to handle any accessory other than the accessory needed to perform the desired food processing function. It will be understood that the storage structure 400 can be placed in the bowl 16 in any orientation, and references to ‘left’, ‘right’ and ‘front’ used above do not imply these features face left, right or front during use.

Similarly, the exploded perspective of the second embodiment of the storage structure 400 shows the attachment of the additional unit 404 does not prevent individual access and removal of the chopping blade 82, dough blade 84, the slicing disk 86, the shredding disk 88, or the spindle 80. Furthermore, the dicing kit 410 is individually accessible from the open top of the additional unit 404.

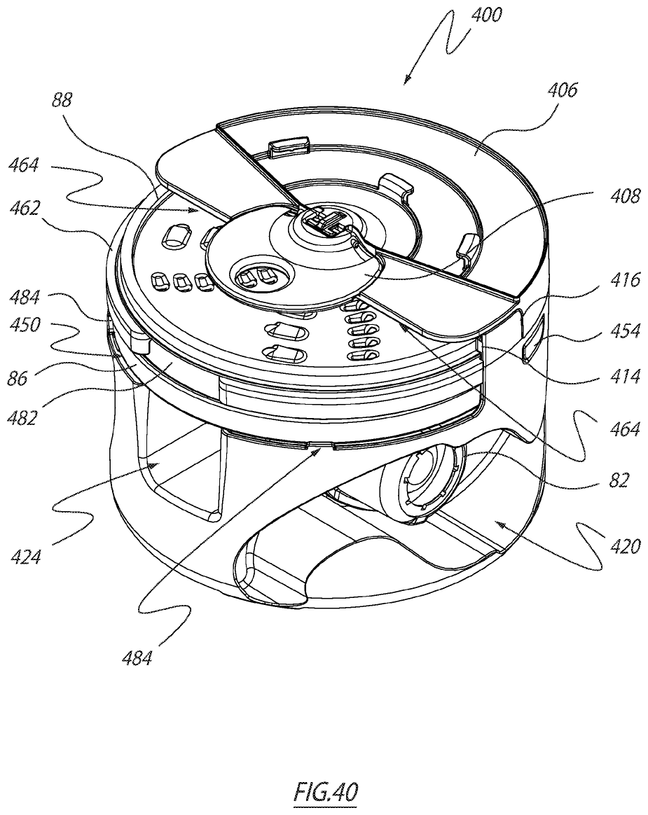

FIG. 40 is a front, right side perspective of the first embodiment of the storage structure 400 showing the adjustable slicing disk 86 stored within the adjustable slicer slot 450 and the grating disk 88 stored within the grating disk slot 464. Access to these disks for removal and replacement is by the finger access recess 424 in the front of the base unit 402 and the front gap 482 in the partition 462 of the cover 406. The thickness of the partition 462 is sufficient to allow users to gain a finger grip on the rim of the adjustable slicing disk 86 and the peripheral rim of the grating disk 88. The finger grip should provide enough purchase on the disks to allow the user to lift the adjustable slicing disk over the disk retention tabs 484 while the shredding disk 88 is to be drawn out of the shredding disk slot 464 past the resistance provided by the disk capture bumps 414.

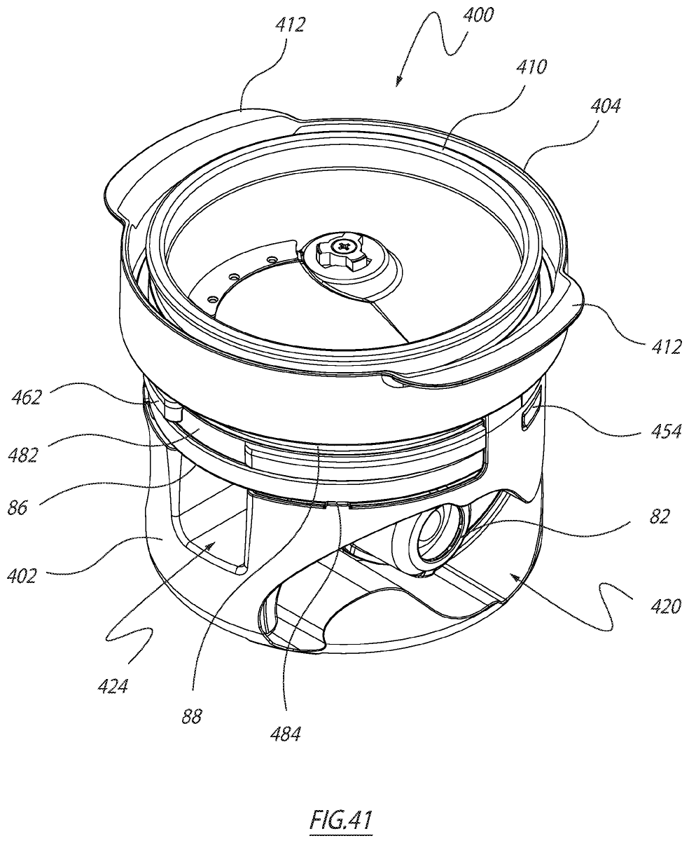

FIG. 41 shows the second embodiment of the storage structure 400 depicting how the shredding disk 88 is still accessible for individual removal via the front gap 482 in the partition 462. With the additional unit 404 attached to the top of the cover 406, a gap remains beneath the base of the additional unit and the rim of the shredding disk 88 allowing sufficient finger grip for removal and replacement of the shredding disk 88.

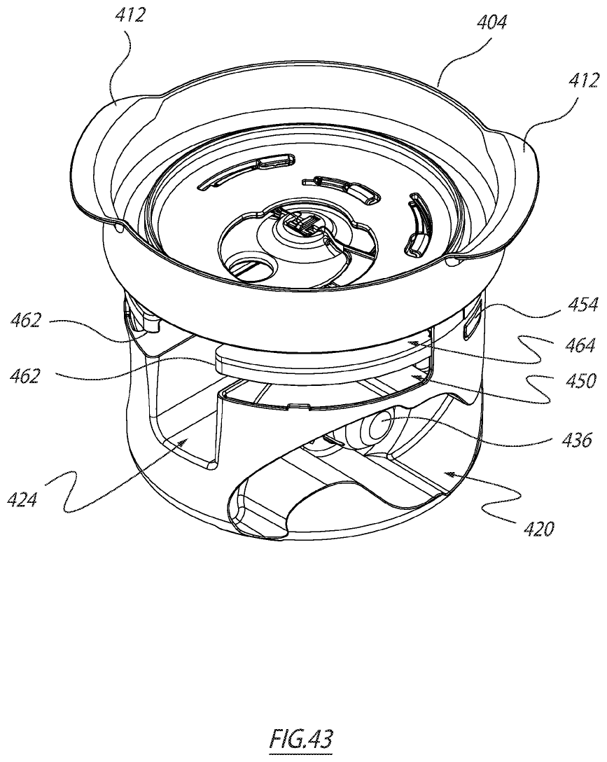

FIGS. 42 and 43 show the additional unit 404 rotated to the unlocked position on the cover 406. As discussed above, FIG. 30 shows the additional unit 404 in the locked position. Rotating the additional unit 404 relative to the base unit 402 through the predetermined angle 486 unlocks the additional unit 404 from the cover 406. As previously described, the additional unit 404 and the cover 406 engage via a bayonet connection between the inwardly bent tabs 438 and outwardly bent tab 444 on the cover 406 and the long arcuate slots 440 and short arcuate slot 446 in the additional unit 404. In the unlocked position, the inwardly bent tabs 438 are within the inward tab openings 442 at the end of the long arcuate slots 440. Likewise, the outwardly bent tab 444 is within the outward tab opening 448 at the end of the short arcuate slot 446. This constitutes the unlocked position of the bayonet connection such that the additional unit 404 can be lifted off the cover 406 using the lift tabs 412.

In the unlocked position, the user is not able to lift the storage structure 400 via the hinged handle 408 on the cover 406. Once the additional unit 404 has been rotated through angle 486 relative to the cover 406, the handle access opening 480 is no longer in registration with the hinged lift handle 408 beneath.

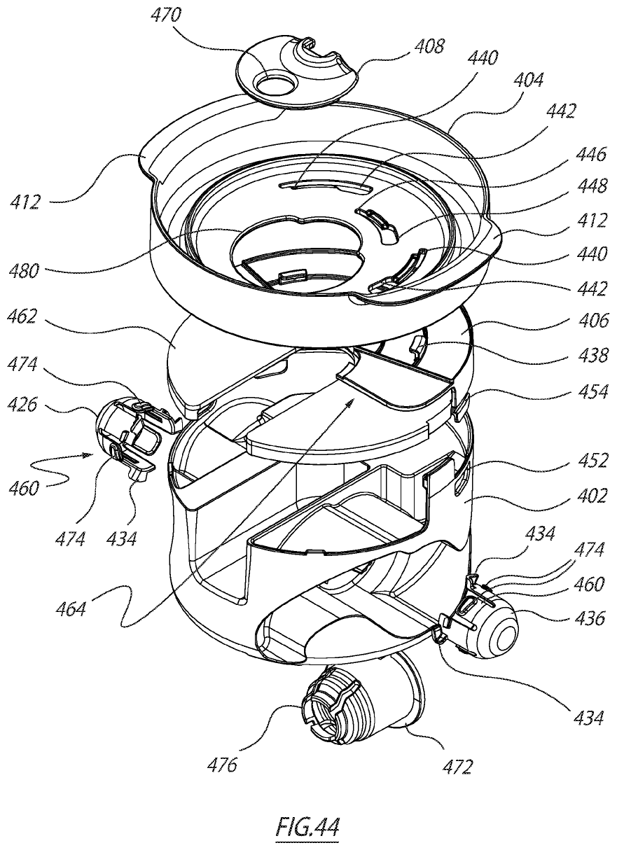

FIG. 44 is an exploded perspective of the second embodiment of the storage structure 400 showing the spindle socket 472, the chopping blade mount 436 and the dough blade mount 426 removed from the base unit 402 for clarity.

FIG. 45 is a perspective of the base unit 402 together with the spindle socket 472, the chopping blade mount 436 and the dough blade mount 426 separated to clearly depict their respective detachable engagement features. The spindle socket 472 has spindle gripping features 476 that are biased into gripping engagement with the sides of the spindle 80 when it is inserted in the socket 472. The strength of the engagement between the spindle griping features 476 and the spindle 80 is configured such that the spindle is securely retained within the socket 472 but easily removed via the user without excessive effort.

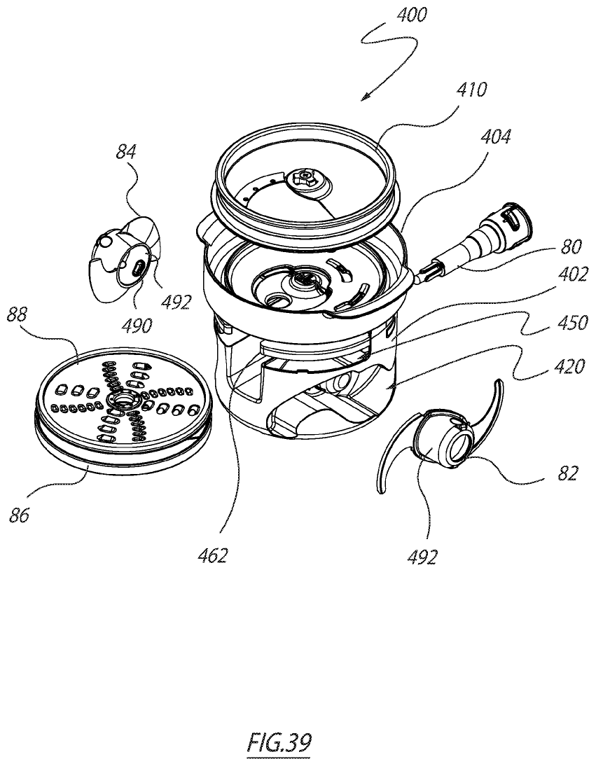

The chopping blade mount 436 and the dough blade mount 426 have detachable engagement features 474 positioned about their respective side walls. The chopping blade mount 436 and the dough blade mount 426 depicted in the Figures have three engagement features 474 each however it will be appreciated that other detachable engagement formations are possible. The detachable engagement features 474 are mounted in a flexible manner to compress inwards as the hub 492 of the accessories 82 and 84 are pushed onto their respective mounts (see FIGS. 38 and 39). The interior of the accessory mount hubs 492 have a complementary set of retention detents 490 to receive the outwardly biased engagement features 474. Once again, the engagement between the engagement features 474 on the accessory mounts 436 and 426 and the accessory hubs 492 is sufficient to securely retain the chopping blade 82 and the dough blade 84 during storage and removal from the bowl 16, but manually removable without excessive effort.

FIGS. 44 and 45 provide a clear depiction of the dough blade mount bayonet tabs 430 and the chopping blade mount bayonet tabs 434. As with the engagement features 474, each of the accessory mounts 426 and 436 are provided with three bayonet tabs (three tabs 430 and three tabs 434) respectively. However, it will be appreciated that other forms of detachable engagement between the accessory mounts 426 and 436 and the base unit 402 would be possible.

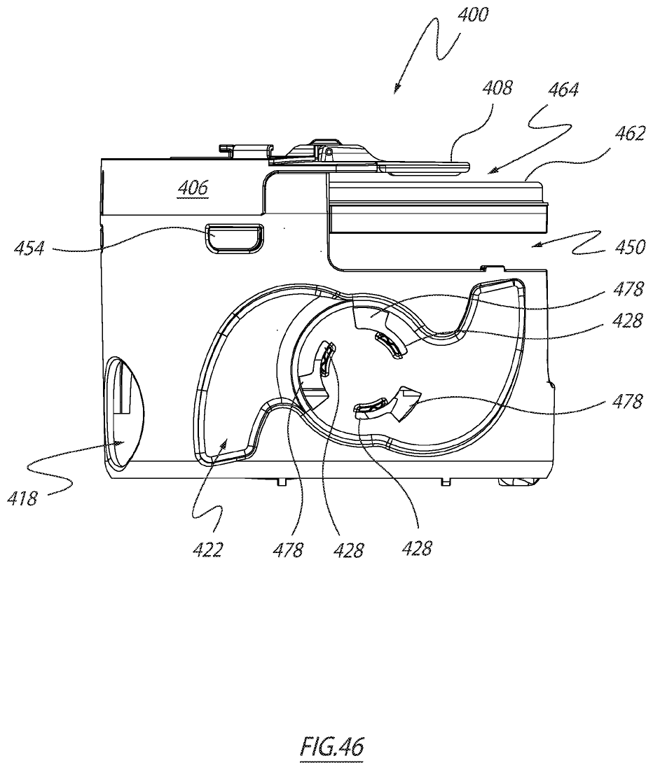

FIG. 46 is a left side elevation of the storage structure 400 according to the first embodiment. This provides a clear depiction of the features in the recess provided bayonet style engagement with the dough blade mount 426. Within the dough blade recess 422 are three equally spaced, concentric arcuate recesses 428. At one end of each of the arcuate recesses 428 is a bayonet tab opening 478. The bayonet tab openings 478 are sized to allow the dough blade mount bayonet tabs 430 to pass through whereupon relative rotation of the dough blade mount 426 and the base unit 402 moves the bayonet coupling to the locked position.

The situation is repeated on the other side of the base unit 402 in the chopping blade recess 420 where the chopping blade recess apertures 432 are three, arcuate, equi-spaced concentric grooves. Likewise, the chopping blade recess apertures 432 include bayonet tab openings to allow the chopping blade mount tab 434 to pass through. Relative rotation of the chopping blade mount 436 and base unit 402 moves the bayonet coupling to the locked position.

FIG. 47 is a vertical cross section of the rear half of the storage structure 400 according to the first embodiment. In the centre of the underside of the base unit 402 is a drive coupling cavity 488. When the storage structure 400 is placed within the processing bowl 16, the spindle drive coupling 109 protruding from the base of the bowl is accommodated wholly within the drive coupling cavity 488. This isolates the drive coupling on the base of the bowl from any contact with parts of the storage structure 400 or the accessories and spindle stored therein. Hence, the storage structure 400, the stored spindle 80 and accessories 82 to 88 are protected from damage due to inadvertent activation of the motorised base 12.

FIG. 48 is a perspective showing the first embodiment of the storage structure 400 with the lift handle 408 rotated to the upright orientation. In the upright orientation, the handle 408 positions the finger hole 470 such that the central axis 494 of the storage structure 400 is substantially colinear with a diameter of the circular finger hole 470. In this way, the storage structure 400 stays substantially level as it is lifted from the processing bowl 16 (not shown).

The invention has been described herein by way of example only. Skilled workers in this field will readily recognize many variations and modification which do not depart from the spirit and scope of the broad inventive concept.

1. A storage structure for a food processing device with a bowl for processing food using different accessories, the storage structure comprising:
a base unit configured to fit within the bowl, and
engagement formations to retain a plurality of the accessories on the base unit for individual removal from the base unit, and replacement into the base unit, without first removing or replacing another of the accessories.

2. A storage structure according to claim 1 wherein the base unit has recesses to store the accessories, each of the recesses having at least one of the engagement formations to detachably engage the accessories such that the accessories are stored within the recesses to prevent direct contact of one of the accessories with another of the accessories.

3. A storage structure according to claim 1, wherein the food processing device has a spindle to engage the accessories for rotation within the bowl, and some of the engagement formations are configured to retain the spindle, such that the spindle is removable from the base unit without requiring removal of any of the accessories stored in the base unit.

4. A storage structure according to claim 3, wherein the base unit has a socket to receive the spindle, the socket having a plurality of the formations for detachably gripping the spindle during storage and allowing manual removal of the spindle by a user.

5. A storage structure according to claim 3, wherein at least one of the recesses is configured for storing a designated one of the accessories only.

6. A storage structure according to claim 5, further comprising a removable mount in the at least one recess, the removable mount having the formations to detachably engage the accessory for storage within the recess.

7. A storage structure according to claim 6, wherein, the removable mount and the at least one recess have complementary bayonet tabs and apertures forming a bayonet connection between the mount and the recess.

8. A storage structure according to claim 1, further comprising a cover for attachment to the base unit, the cover and the base unit defining at least one slot to retain one of the accessories formed as a disk for rotation in the bowl.

9. A storage structure according to claim 8, wherein the cover and the base unit define a plurality of the slots to individually retain one of the disks respectively.

10. A storage structure according to claim 8, further comprising an additional unit for detachable engagement with the cover, the additional unit being configured to hold an additional accessory for the food processing device, such that the additional unit does not prevent removal of any of the plurality of accessories stored in the storage structure.

11. A storage structure according to claim 1, wherein the bowl has a base with a spindle drive coupling, and the storage structure further comprises a drive coupling cavity for accommodating the spindle drive coupling when the base unit is within the bowl such that the spindle drive coupling does not touch any part of the storage structure or the plurality of accessories.

12. A storage structure according to claim 1 configured to be lifted out of the bowl without requiring user contact with any of the accessories.

13. A storage structure according to claim 12, wherein the cover has a lift handle with hinged connection for rotation to an upright orientation to lift the storage structure from the bowl.

14. A storage structure according to claim 12, wherein the additional unit has lift tabs for lifting the storage structure from the bowl.

15. A storage structure according to claim 1, wherein the plurality of accessories includes one or more of:
a. A chopping blade;
b. A dough blade;
c. An adjustable slicing disk; and
d. An adjustable shredding disk.

16. A storage structure according to claim 15 wherein the additional accessory is a dicing kit.

17. A storage structure according to claim 1, wherein the food processing device has a lid for the bowl wherein the storage structure is configured to fit in the bowl with the lid on the bowl.

18. A storage structure according to claim 17, wherein the food processing device has a lid for the bowl wherein the additional unit is configured to receive the lid to cover the additional accessory.

19-26. (canceled)
